(19) United States
(12) Patent Application Publication
(10) Pub. No.: US 2022/0064478 A1
(43) Pub. Date: Mar. 3, 2022

(54) PROCESS FOR MAKING LOW DENSITY SPRAY POLYURETHANE FOAM FOR INSULATION, SOUND ABATEMENT, AND AIR SEALING OF BUILDING ENCLOSURES

(71) Applicant: SES Foam, LLC, Spring, TX (US)

(72) Inventors: Jose Luna, Pasadena, TX (US); Charles Valentine, Spring, TX (US)

(73) Assignee: SES Foam, LLC, Spring, TX (US)

(21) Appl. No.: 17/410,596

(22) Filed: Aug. 24, 2021

Related U.S. Application Data
(60) Provisional application No. 63/069,968, filed on Aug. 25, 2020.

(51) Int. Cl. C09D 175/08; C09D 5/18; C09D 5/02; C09D 7/48; C09D 7/63; E04B 1/76

(52) U.S. Cl. CPC C09D 175/08; C09D 5/18; C09D 5/021; E04B 1/76; C09D 7/48; C09D 7/63; C09D 5/027

(57) ABSTRACT

This disclosure provides for new low density, open cell polyurethane (PUR) foams, which can be prepared using a combination of precursors and conditions, for example, an off-ratio A-side:B-side volume ratio (v:v) which includes a higher volume of A-side than the volume of B-side, an aromatic polyisocyanate component having an isocyanate functionality of from about 2.5 to about 3.0, and an Isocyanate Index of from about 20 percent to about 40 percent. Using the processes and precursors disclosed herein, polyurethane foams having a density of from about 0.25 lb/ft³ to about 0.45 lb/ft³ can be obtained.

### CROSS REFERENCE TO RELATED APPLICATIONS

This application claims the benefit of and priority to U.S. Provisional Application No. 63/069,968, filed Aug. 25, 2020, which is hereby incorporated herein by reference in its entirety.

### TECHNICAL FIELD OF THE DISCLOSURE

This disclosure relates to low density polyurethane foams having good insulation, air sealing, and sound abatement properties, and compositions and processes for making the same.

### BACKGROUND OF THE DISCLOSURE

The need to develop more energy efficient buildings is increasingly important in view of environmental demands, and this need is reflected in updates to national and international building codes for energy efficiency. Revisions to the International Energy Conservation Code (IECC), the International Residential Code (IRC), the American Society of Heating, Refrigerating and Air-Conditioning Engineers (ASHRAE), and the like, all manifest the growing demand to improve energy efficiency. Requirements include increasing thermal resistance properties and improving air sealing effectiveness, which highlight the need for innovations in building materials and construction.

Traditional fibrous insulation provides the necessary thermal resistance but lacks the capability to meet the more stringent air sealing requirements. To compensate for this deficiency, builders and insulation contractors are required to utilize additional technologies such as one-component foams and caulks for the construction to pass air sealing requirements. This complication requires mobilization of different work crews, runs the risk of failing air sealing standards thereby requiring multiple mobilizations, and increases costs.

Therefore, there is a need to address these problems and additional costs of using traditional fibrous insulation. It would be useful if technologies such as spray polyurethane (PUR) foam could provide the needed performance, at least because the application of these foams is convenient and cost-effective, and because foams can be used to form multiple control layers in the building envelope. In particular, it would be helpful if low density foams could be developed that address the insulation and air sealing requirements for energy efficiency, as well as delivering good sound abatement properties.

### SUMMARY OF THE DISCLOSURE

In an aspect, this disclosure provides new, low density, spray polyurethane (PUR) foams and methods for the preparation, including new chemistries and processes parameters, in which the foams can deliver the combination of good insulation properties, air sealing qualities, and sound abatement. The spray polyurethane foam is a fluid-applied, expanding insulation which can deliver a viable alternative to traditional fibrous insulation. With the disclosed, low density open cell foam providing the function of air sealing and insulation, additional advantages may include enhanced sound abatement, for example, a Sound Transmission Coefficient level roughly two- to three STC units higher than that of traditional fibrous insulation. Further advantages include the flame retardant properties when the foaming compositions are combined with a flame retardant as disclosed.

In one aspect, it has been found that very low density polyurethane foams, for example, in the range of from about 0.25 lb/ft³ (pounds per cubic foot) to about 0.45 lb/ft³, can be prepared using a combination of precursors and conditions, including: [1] an “off-ratio” A-side:B-side volume ratio (v:v) which includes a higher volume of A-side than the volume of B-side and therefore which departs from the roughly 1:1 (v:v) ratio common in conventional commercially available spray polyurethane foams; [2] an aromatic polyisocyanate component having an isocyanate functionality of from about 2.5 to about 3.0; and [3] an Isocyanate Index of from about 20 to about 40 (expressed as a percentage).

Therefore, in an aspect, this disclosure provides a low density polyurethane (PUR) foam, in which the foam can comprise the contact product of:
(a) a first reaction composition (A-side) comprising an aromatic polyisocyanate component having an isocyanate functionality of from about 2.5 to about 3.0; and
(b) a second reaction composition (B-side) comprising:
a polyether polyol characterized by a Hydroxyl Number (mg KOH/g) of from about 20 to about 45;
a polyurethane producing catalyst in a concentration of from 5 wt % to 12 wt % in the second reaction composition (B-side);
a flame retardant;
a surfactant; and
water;
wherein the first reaction composition (A-side) and the second reaction composition (B-side) are contacted in amounts to provide [1] an A-side:B-side volume ratio (v:v) of from 1.2:1 to 2:1, and [2] an Isocyanate Index of 20 to 40 (expressed as a percentage); and
wherein the low density PUR foam has a density from about 0.25 lb/ft³ to about 0.45 lb/ft³.

Accordingly, there is also provided a process for making a low density polyurethane (PUR) foam, in which the process can comprise contacting: (a) a first reaction composition (A-side) comprising an aromatic polyisocyanate component having an isocyanate functionality of from about 2.5 to about 3.0; and (b) a second reaction composition (B-side) comprising: [1] a polyether polyol characterized by a Hydroxyl Number (mg KOH/g) of from about 20 to about 40; [2] water (an aqueous blowing agent); [3] a polyurethane producing catalyst in a concentration of from 6 wt % to 11 wt % in the second reaction composition (B-side); [4] a flame retardant; and [5] a surfactant; wherein the first reaction composition (A-side) and the second reaction composition (B-side) are contacted in amounts to provide [a] an A-side:B-side volume ratio (v:v) of from 1.2:1 to 2:1, and [a] an Isocyanate Index of 20 to 40 (expressed as a percentage); and wherein the low density PUR foam has a density from about 0.25 lb/ft³ to about 0.45 lb/ft³.

These and other embodiments and aspects of the processes, methods, and compositions are described more fully in the Detailed Description and claims and further disclosure such as the Examples provided herein.

### DETAILED DESCRIPTION OF THE DISCLOSURE

### Definitions

To define more clearly the terms used herein, the following definitions are provided, and unless otherwise indicated or the context requires otherwise, these definitions are applicable throughout this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Regarding claim transitional terms or phrases, the transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. Unless specified to the contrary, describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of, apply only to feature class to which is utilized and it is possible to have different transitional terms or phrases utilized with different features within a claim. For example a method can comprise several recited steps (and other non-recited steps) but utilize a catalyst composition preparation consisting of specific steps but utilize a catalyst composition comprising recited components and other non-recited components. While compositions and methods are described in terms of “comprising” various components or steps, the compositions and methods can also “consist essentially of” or “consist of” the various components or steps.

The terms “a,” “an,” and “the” are intended, unless specifically indicated otherwise, to include plural alternatives, e.g., at least one. For instance, the disclosure of “a polyol” is meant to encompass one polyol compound, or mixtures or combinations of more than one polyol compound unless otherwise specified.

The terms “configured for use” or “adapted for use” and similar language is used herein to reflect that the particular recited structure or procedure is used in a polyurethane spray foam system or process, including for use with high pressure proportioners used in polyurethane spray foam systems. For example, unless otherwise specified, a particular structure “configured for use” means it is “configured for use in a polyurethane spray foam system” and therefore is designed, shaped, arranged, constructed, and/or tailored to effect a combination of an A-side composition and a B-side composition resulting in a polymerization, as would have been understood by the skilled person.

The terms “flame retardant chemical”, “fire retardant chemical”, or simply “flame retardant” or “fire retardant” when used herein to refer to the additive or treatment that is used to treat or condition a material such as a PUR foam refers to an element, a chemical compound, agent or composition which has the ability to reduce or eliminate the tendency of a substance or a substrate to which it is added to burn when the substance or substrate is exposed to a flame or fire. The flame retardant chemicals selected are suitable for combination with or use with the one or more substances or substrates which they treat or to which they are added, which may be determined by those of skill in the art.

Terms such as “flame retardant”, “fire retardant”, “flame resistant,” “fire resistant,” and the like may also be used to refer to a substance to which a flame retardant chemical has been added or to a substrate which has been treated or coated with a flame retardant chemical. For example, this disclosure provides for a flame retardant polyurethane (PUR) foam, one component of which is a flame retardant chemical. In one aspect, these terms may be used herein to refer to substances or materials which: (a) do not support a flame, fire and/or combustion, either while a flame or fire is present, or once a source of heat or ignition is removed; and/or (b) are retardant to, or incapable of, burning (being essentially fireproof, that is undergoing virtually no change when exposed to flame, fire and/or combustion process). A flame resistant substance, material, or substrate may char and/or melt.

The term “open cell” or “open cell foam”, as used herein, refers to a foam having at least 70 percent open cells as measured in accordance with ASTM D6226.

The term “functionality” when used to describe a polyisocyanate and similar terms such “isocyanate functionality”, “polyisocyanate functionality”, or as “MDI functionality”, refers to the number average isocyanate functionality, that is, NCO moieties, of all isocyanates per mole used in the polyisocyanate component for preparing a polyurethane foam. Isocyanate functionality may be abbreviated Fn.

The “isocyanate content” and similar terms such as “NCO content” can be expressed as a weight percentage (%), which is the weight of all the isocyanate (NCO) moieties (equivalent weight of 42.017 g for one NCO functional group) in the polyisocyanate component divided by the weight of the polyisocyanate component, expressed as a percentage (wt %) The isocyanate content can also be expressed as a fraction.

The isocyanate “functionality” is the number of reactive NCO groups per molecule in an isocyanate molecule or in a polymeric isocyanate, such as in MDI or polymeric MDI. For example, most MDI samples contain a blend of monomeric and polymeric MDI, and the isocyanate “functionality” is an average functionality across the different molecular and polymeric species.

As used herein, “MDI” refers to methylene diphenyl diisocyanate, also called diphenylmethane diisocyanate, and the isomers thereof. MDI (methylene diphenyl diisocyanate) exists as one of three isomers (4,4′ MDI, 2,4′ MDI, and 2,2′ MDI), or as a mixture of two or more of these isomers. As used herein, unless specifically stated otherwise, “MDI” may also refer to, and encompass, polymeric MDI (sometimes termed “PMDI”). Polymeric MDI is a compound that has a chain of three or more benzene rings connected to each other by methylene bridges, with an isocyanate group attached to each benzene ring. For example, one conventional MDI may have an average functionality from about 2.1 to about 3, inclusive, with a typical viscosity of about 200 mPa to 1,000 mPa at 25° C.

The terms “Isocyanate Index”, “NCO index”, “ISO Index” and the like are used as understood by the person of ordinary skill to refer to the ratio of the number of NCO groups or equivalents (from the A-side) to the number of isocyanate-reactive hydrogen atoms or equivalents (from the B-side) that are used in a formulation. The Isocyanate Index can be reported as either a fraction or a percentage, therefore, the Isocyanate Index reported as a percentage is calculated according to the following equation:

$$\frac{[ NCO ] \times 100}{[ active hydrogens ]} . \qquad ( Eq . 1 )$$

In other words, the NCO index expresses the amount of isocyanate actually used in a formulation with respect to the amount of isocyanate theoretically required for a stoichiometric reaction with the amount of isocyanate-reactive hydrogens used in the formulation. An Isocyanate Index of 100 (percent) reflects a 1:1 ratio (molar or number) of NCO groups to active hydrogens. In the Examples, the NCO index is reported both as a fraction and a percentage.

The term “Hydroxyl Number” (abbreviated OHN) or “Hydroxyl Value” (abbreviated OHV), or simply “hydroxyl number” or “hydroxyl value” of a chemical substance is a characteristic of a chemical substance which contains free hydroxyl groups. “Hydroxyl Number” is defined as the number of milligrams of potassium hydroxide (KOH) equivalent to the hydroxyl content in one (1) gram of polyol or other compound containing free hydroxyl groups. For example, the Hydroxyl Number can be defined as the number of milligrams of potassium hydroxide (KOH) required to neutralize the acetic acid taken up upon acetylation of one (1) gram of the chemical substance which contains free hydroxyl groups. Therefore, Hydroxyl Number units are expressed in mg KOH/g chemical substance. Based upon this definition, the Hydroxyl Number of a chemical substance can be calculated according to the following equation:

$$Hydroxyl Number = \frac{56100}{Equivalent Weight ( EqWt )} . \qquad ( Eq . 2 )$$

The numerator 56,100 arises from the molecular weight of potassium hydroxide of 56.1 g/mol, and the 1,000 milligrams present in one gram of sample.

The terms “optional” or “optionally” are used to mean that the subsequently described component, event, or circumstance may or may not be used or occur, and that the description includes instances where the component, event, or circumstance occurs and instances where it does not. For example, the phrase “optionally substituted” means that the compound referenced may or may not be substituted and that the description includes both unsubstituted compounds and compounds where there is substitution.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, by disclosing a temperature of from 70° C. to 80° C., Applicant's intent is to recite individually 70° C., 71° C., 72° C., 73° C., 74° C., 75° C., 76° C., 77° C., 78° C., 79° C., and 80° C., and including any ranges and combinations of ranges between any of these values, and these methods of describing such ranges are interchangeable. Moreover, all numerical end points of ranges disclosed herein are approximate, unless excluded by proviso. As a representative example, if Applicant states that one or more steps in the processes disclosed herein can be conducted at a temperature in a range from 10° C. to 75° C., this range should be interpreted as encompassing temperatures in a range from “about” 10° C. to “about” 75° C.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” can mean±15% of the stated value, ±10% of the stated value, ±5% of the stated value, ±3% of the stated value, or ±2% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any individual substituents, analogs, compounds, ligands, structures, or groups thereof, or any members of a claimed group, if for any reason Applicant chooses to claim less than the full measure of the disclosure, for example, to account for a reference or prior disclosure that Applicant may be unaware of at the time of the filing of the application.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

### GENERAL DESCRIPTION

Spray polyurethane foam is a fluid-applied, expanding insulation which has proven itself as a viable alternative to traditional fibrous insulation. It forms multiple control layers in the building envelope. With low density open cell foam the primary functions are air sealing and insulation. Sound abatement is a secondary characteristic of the polyurethane foams, which can deliver about 2-3 Sound Transmission Coefficient levels higher than traditional fibrous insulation. This disclosure provides a procedure for making a low density spray foam insulation utilizing unique chemistries and processing and the new foams resulting therefrom.

Therefore, this disclosure provides for new low-density polyurethane (PUR) foams having good insulation, air sealing, and sound abatement properties can be prepared using a combination of precursors and conditions, including: [1] an “off-ratio” A-side:B-side volume ratio (v:v) which includes a higher volume of A-side than the volume of B-side and therefore which departs from the roughly 1:1 (v:v) ratio common in conventional polyurethanes; [2] an aromatic polyisocyanate component having an isocyanate functionality of from about 2.5 to about 3.0; and [3] an Isocyanate Index of from about 20 to about 40 (expressed as a percentage).

In an aspect, these new low density foams are open-cell foams which can incorporate a flame retardant. The disclosed combination of foam properties and process parameters provide the low density foams which are capable of meeting standards related to flame retardant properties, thermal barrier properties, and ignition barrier properties and allow these foams to pass certain thermal barrier tests in the absence of the code-prescribed protective covering such as specified in the model building codes.

Therefore, in an aspect, this disclosure provides a low density polyurethane (PUR) foam, the foam comprising the contact product of:
(a) a first reaction composition (A-side) comprising an aromatic polyisocyanate component having an isocyanate functionality of from about 2.5 to about 3.0; and
(b) a second reaction composition (B-side) comprising:
a polyether polyol characterized by a Hydroxyl Number (mg KOH/g) of from about 20 to about 45;
water (an aqueous blowing agent);
a polyurethane producing catalyst in a concentration of from 5 wt % to 12 wt % in the second reaction composition (B-side);
a flame retardant; and
a surfactant;
wherein the first reaction composition (A-side) and the second reaction composition (B-side) are contacted in amounts to provide [1] an A-side:B-side volume ratio (v:v) of from 1.2:1 to 2:1, and [2] an Isocyanate Index of 20 to 40 (expressed as a percentage); and
wherein the low density PUR foam has a density from about 0.25 lb/ft³ to about 0.45 lb/ft³.
   Associated processes for making the polyurethane foams are also disclosed herein.

According to an aspect, the components used to make the foams of this disclosure may be used with high pressure systems, and the resulting foams may be referred to as high pressure foams. For example, spray foam systems which can be used in producing the disclosed foams include those with proportioners operating at from about 500 psi (pounds per square inch) to about 2,000 psi, to pressurize the reaction compositions.

These and other aspects of the present disclosure are explained in additional detail herein, as follows.

Polyisocyanate Component. As described above, the first reaction composition which is referred to as the A-side can comprise a polyisocyanate component, including an aromatic polyisocyanate. The polyisocyanate component can be a polyisocyanate compound or a mixture of polyisocyanate compounds. In an aspect, the polyisocyanate component can comprise methylene diphenyl diisocyanate (MDI) including any or all isomers thereof, polymeric methylene diphenyl diisocyanate (PMDI), or any combination thereof. According to a further aspect, the polyisocyanate component can comprise 2,2′-methylene diphenyl diisocyanate (2,2′-MDI), 4,4′-methylene diphenyl diisocyanate (4,4′-MDI), polymeric methylene diphenyl diisocyanate (PMDI), or any combination thereof. Examples of a polyisocyanate component that are useful in the foams and processes disclosed herein include, but are not limited to, WANNATE® PM-700 and WANNATE® PM-200 from Wanhau USA.

In another aspect, the polyisocyanate component can comprise from about 20 wt % to about 80 wt % of methylene diphenyl diisocyanate (MDI) and from about 80 wt % to about 20 wt % of polymeric methylene diphenyl diisocyanate (polymeric MDI or “PMDI”). Alternatively, the polyisocyanate component can comprise from about 25 wt % to about 75 wt % of methylene diphenyl diisocyanate (MDI) and from about 75 wt % to about 25 wt % of polymeric methylene diphenyl diisocyanate (polymeric MDI or “PMDI”), for example, according to the product specification information. Alternatively, the polyisocyanate component can comprise from about 30 wt % or about 35 wt % to about 65 wt % or about 70 wt % of polymeric methylene diphenyl diisocyanate (polymeric MDI or “PMDI”) and from about 70 wt % or about 65 wt % to about 35 wt % or about 30 wt % methylene diphenyl diisocyanate MDI.

In an aspect, the first reaction composition (A-side) can comprise an aromatic polyisocyanate component having an isocyanate functionality of from about 2.5 to about 3.0. In a further aspect, the polyisocyanate component as used herein can have an isocyanate functionality of from about 2.5 to about 2.9; alternatively, from about 2.6 to about 2.9; alternatively, from about 2.6 to about 2.8; or alternatively, from about 2.7 to about 2.8. Further still, the polyisocyanate component as used herein can have an isocyanate functionality of about 2.5, about 2.6, about 2.7, about 2.8, about 2.9, or about 3.0, or any ranges or combinations of ranges between any of these values.

In yet another aspect, the polyisocyanate component as used herein can have an NCO content (wt %) of from 25 wt % to about 35 wt %, alternatively from about 26 wt % to about 33 wt %, or alternatively still from about 27 wt % to about 30 wt %. Alternatively, the polyisocyanate component used herein can have an NCO content (wt %) of about 25 wt %, about 26 wt %, about 27 wt %, about 28 wt %, about 29 wt %, about 30 wt %, about 31 wt %, about 32 wt %, about 33 wt %, about 34 wt %, or about 35 wt %, or any ranges or combinations of ranges between any of these values.

In one aspect, the polyisocyanate component as used herein can have a viscosity (25° C., mPa·S) of from about 100 mPa·S (cP) to about 1,050 mPa·S (cP), or alternatively, the polyisocyanate component may also have a viscosity (25° C., mPa·S) of from about 125 mPa·S (150 cP) up to about 950 mPa·S (1,050 cP). For example, in an aspect, the polyisocyanate component may also have a viscosity (25° C., mPa·S) of from about 125 cP to about 400 cP, alternatively from about 125 cP to about 350 cP, or alternatively from about 150 cP to about 300 cP. In a further example, the polyisocyanate component may also have a viscosity of from about 575 cP to about 1,000 cP, alternatively from about 600 cP to about 950 cP, or alternatively from about 650 cP to about 900 cP. The polyisocyanate component may also have a viscosity (25° C., mPa·S) of about 100 cP, about 125 cP, about 150 cP about 175 cP, about 200 cP, about 225 cP, about 250 cP, about 275 cP, about 300 cP, about 325 cP, about 350 cP, about 375 cP, about 400 cP, about 425 cP, about 450 cP, about 475 cP, about 500 cP, about 525 cP, about 550 cP, about 575 cP, about 600 cP, about 625 cP, about 650 cP, about 675 cP, about 700 cP, about 750 cP, about 800 cP, about 850 cP, about 900 cP, about 950 cP, about 1,000 cP, or about 1,050 cP, or any ranges or combinations of ranges between any of these values. It will be appreciated by the skilled artisan that the SI units for dynamic viscosity of mPa·S are equivalent to the cgs units of centipoise, as 1 cP=10⁻³ Pa·S=1 mPa·S.

An example of a polyisocyanate component that is useful in the foams and processes disclosed herein is WANNATE® PM-700 from Wanhau USA, which can comprise from about 30 wt % to about 70 wt % of polymeric methylene diphenyl diisocyanate (polymeric MDI or “PMDI”) and from about 70 wt % to about 30 wt % methylene diphenyl diisocyanate MDI according to the product specification information. This PM-700 can have a viscosity (25° C., mPa·S) of from about 600 cP to about 850 cP, for example, about 700 cP. The NCO content (wt %) of this PM-700 can be from about 30.0 wt % to about 32.0 wt %, and its density is between about 1.22 gm/cm³ to about 1.25 gm/cm³.

In some embodiments, the polyisocyanate component used in the contact product to make the polyisocyanate foam can have an isocyanate functionality of from about 3.0 to about 3.1, an NCO content (wt %) of from about 29 wt % to about 33 wt %, and a viscosity (25° C., mPa·S) of from about 650 cP to about 750 cP.

Another example of a polyisocyanate component that is useful in the foams and processes disclosed herein is WANNATE® PM-200 from Wanhau USA, which can comprise from about 30 wt % to about 70 wt % of polymeric methylene diphenyl diisocyanate (polymeric MDI or “PMDI”) and from about 70 wt % to about 30 wt % methylene diphenyl diisocyanate MDI according to the product specification information. This PM-200 can have a viscosity (25° C., mPa·S) of from about 150 cP to about 250 cP, for example, about 200 cP. The NCO content (wt %) of this PM-200 can be from about 30.5 wt % to about 32.0 wt %, its density can be from about 1.22 gm/cm³ to about 1.25 gm/cm³, and its NCO functionality can be from about 2.6 to about 2.7.

In some embodiments, the polyisocyanate component used in the contact product to make the polyurethane foam can have an isocyanate functionality of from about 2.5 to about 2.7, an NCO content (wt %) of from about 30 wt % to about 32.5 wt %, and a viscosity (25° C., mPa·S) of from about 150 cP to about 300 cP.

In one aspect of the polyurethane foam and the process for making the polyurethane foam, the first reaction composition (A-side) can comprise the polyisocyanate, alternatively the first reaction composition (A-side) can consist essentially of the polyisocyanate, or alternatively the first reaction composition (A-side) can consist of the polyisocyanate. That is, the A-side can include only a sample of the polyisocyanate, and can include only impurities typically present in a commercially produced or commercially available sample of the polyisocyanate.

In a further aspect, the first reaction composition (A-side) can comprises the polyisocyanate in at least about 95 wt % of the first reaction composition. In some aspects, the remainder of the A-side composition can comprise, for example, a surfactant, a plasticizer, or a combination thereof.

Polyether Polyol. As described above, the second reaction composition which is referred to as the B-side can comprise a polyether polyol, which can be a polyether polyol compound or a mixture of polyether polyol compounds. According to an aspect of the disclosure, the polyether polyol can be characterized by a Hydroxyl Number (mg KOH/g) of from about 20 to about 45. The polyether polyol can also be characterized by a Hydroxyl Number (mg KOH/g) of from about 25 to about 42, or alternatively from about 28 to about 38. All ranges and combinations of ranges between these high and low Hydroxyl Numbers are encompassed in this disclosure. In another aspect, the polyether polyol can be characterized by a Hydroxyl Number (mg KOH/g) of about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, or about 45, or any ranges or combinations of ranges between any of these values.

In some embodiments, the second reaction composition (B-side) can comprise other polyether polyols which can function as cross-linkers, stabilizing agents, and the like, and which can have very different properties such as Hydroxyl Number, molecular weight, and the like as compared with the polyether polyols described above having a Hydroxyl Number (mg KOH/g) of from about 25 to about 42. These latter polyether polyols having a Hydroxyl Number from about 25 to about 42 can be further characterized by the molecular weight, hydroxyl functionality, and so forth disclosed herein.

According to a further aspect of the disclosure, the polyether polyol characterized by the Hydroxyl Number disclosed above can also be characterized by a molecular weight (weight average or number average) of from about 250 g/mol to about 6,000 g/mol, alternatively, from about 1,000 g/mol to about 5,500 g/mol, alternatively, from about 2,000 g/mol to about 5,250 g/mol, or alternatively from about 4,000 g/mol to about 5,000 g/mol. In one aspect, this polyether polyol can be characterized by a molecular weight (weight average or number average) of about 250 g/mol, about 300 g/mol, about 350 g/mol, about 400 g/mol, about 450 g/mol, about 500 g/mol, about 600 g/mol, about 700 g/mol, about 800 g/mol, about 900 g/mol, about 1,000 g/mol, about 1,250 g/mol, about 1,500 g/mol, about 1,750 g/mol, about 2,000 g/mol, about 2,250 g/mol, about 2,500 g/mol, about 2,750 g/mol, about 3,000 g/mol, about 3,250 g/mol, about 3,500 g/mol, about 3,750 g/mol, about 4,000 g/mol, about 4,250 g/mol, about 4,500 g/mol, about 4,750 g/mol, about 5,000 g/mol, about 5,250 g/mol, about 5,500 g/mol, about 5,750 g/mol, or about 6,000 g/mol, or any ranges or combinations of ranges between any of these values.

In still another aspect of the disclosure, the polyether polyol characterized by the Hydroxyl Number disclosed above can also be characterized by a hydroxyl functionality of from 2 to 8; alternatively, from 2 to 6. alternatively, from 2 to 4, or alternatively, from 2 to 3. In an aspect, this polyether polyol also can be characterized by a hydroxyl functionality of about 2, about 3, about 4, about 5, about 6, about 7, or about 8, or any ranges or combinations of ranges between any of these values.

According to another aspect, the second reaction component (B-side) can comprise the polyether polyol having the disclosed Hydroxyl Number in a concentration of from about 10 wt % to about 50 wt %, alternatively from about 12 wt % to about 40 wt %, alternatively from about 15 wt % to about 30 wt %, or alternatively, from about 18 wt % to about 28 wt % in the second reaction component, including any sub-ranges and combinations of sub-ranges encompassed in these ranges. In an aspect, the second reaction composition can comprise the polyether polyol having the disclosed Hydroxyl Number in a concentration of about 10 wt %, about 12 wt %, about 13 wt %, about 15 wt %, about 18 wt %, about 20 wt %, about 22 wt %, about 25 wt %, about 28 wt %, about 30 wt %, about 32 wt %, about 35 wt %, about 38 wt %, about 40 wt %, about 42 wt %, about 45 wt %, about 48 wt %, or about 50 wt % of the second reaction component, or any ranges or combinations of ranges between any of these values.

In an aspect, the polyether polyol of the second reaction composition can comprise or can be selected from polyoxyethylene diols (glycols), polyoxyethylene triols, polyoxyethylene tetrols, polyoxyethylene pentols, polyoxyethylene hexols, polyoxypropylene diols (glycols), polyoxypropylene triols, polyoxypropylene tetrols, polyoxypropylene pentols, polyoxypropylene hexols, or any combination thereof. The polyether polyol also can comprise or can be selected from polypropylene glycol, polyethylene glycol, polytetramethylene glycol, glycerol triols, polyether tetrols, polyether pentols, aliphatic amine tetrols, aromatic amine tetrols, sorbitol, trimethyolpropane (TMP), or pentaerythritol. The polyether polyol also may be formed from the addition of ethylene oxide, propylene oxide, or other (C₄ to C₈) alkylene oxides, or any combination thereof, added to any of these polyols.

In embodiments, the polyether polyol of the second reaction composition can be formed from the addition of ethylene oxide, propylene oxide, or a combination thereof added simultaneously or sequentially, to at least one polyol, at least one polyether polyol, at least one other type compound having multiple active hydrogens such as a polyamine, or any combination thereof. For example, in an aspect, the polyether polyol can be formed from the addition of ethylene oxide, propylene oxide, or a combination thereof added simultaneously or sequentially, to an active hydrogen component selected from ethylene glycol, propylene glycol, diethylene glycol, dipropylene glycol, tripropylene glycol, trimethyolpropane (TMP), glycerol, pentaerythritol, sorbitol, sucrose, ethylenediamine, toluene diamine, or any combination thereof.

The polyether polyol, in an aspect, can be formed from the addition of ethylene oxide, propylene oxide, other alkylene oxides, or a combination thereof being added simultaneously or sequentially, to an active hydrogen component in the presence of a catalyst. For example, the catalyst can comprise or can be selected from a metal hydroxide, a double metal cyanide catalyst, or a combination thereof. The polyether polyol of the second reaction component can be ethylene oxide terminated to provide a high primary hydroxyl content, propylene oxide terminated to provide a high secondary hydroxyl content, or the polyether polyol can be a combination of ethylene oxide terminated and propylene oxide terminated.

In another aspect, the polyether polyol can comprise or can be selected from: an alkylene oxide adduct of a non-reducing sugar or a sugar derivative; an alkylene oxide adduct of phosphorus and polyphosphorus acids; an alkylene oxide adduct of polyphenols; polyols prepared from natural oils such as castor oil; an alkylene oxide adduct of a C₂ to C₆₀, C₂ to C₄₀, or C₂ to C₂₀ polyhydroxyalkane; or any combination thereof.

According to a further aspect of the disclosure, the polyether polyol of the second reaction composition can comprise or can be selected from an alkylene oxide adduct of 1,3-dihydroxypropane, 1,3-dihydroxybutane, 1,4-dihydroxybutane, 1,4-dihydroxyhexane, 1,5-dihydroxyhexane, 1,6-dihydroxyhexane, 1,2-dihydroxyoctane, 1,3-dihydroxyoctane, 1,4-dihydroxyoctane 1,6-dihydroxyoctane, 1,8-dihydroxyoctane, 1,10-dihydroxydecane, glycerol, 1,2,4-trihydroxybutane, 1,2,6-trihydroxyhexane, 1,1,1-trimethylolethane, 1,1,1-trimethylolpropane, pentaerythritol, caprolactone, polycaprolactone, xylitol, arabitol, sorbitol, mannitol, or any combination thereof.

Examples of useful commercial polyether polyols include, but are not limited to, Carpol® GP-4520 from Carpenter Company, which is a glycerin-initiated polyether polyol, in which the resulting material has a functionality of three and an average molecular weight of 4500 Da (Daltons). The triol is polymerized with propylene oxide and then capped with 20% ethylene oxide. Other examples of commercial polyether polyols which can be used according to this disclosure include, but are not limited to, Pluracol® 816, which is a high molecular weight triol, having a nominal molecular weight of about 4800 Da. Still further examples of commercial polyether polyols which can be used according to this disclosure include, but are not limited to, Arcol® 11-34, which is a high molecular weight polyether polyol, specifically a polyoxypropylene triol specially modified with ethylene oxide, having a nominal or average molecular weight of about 4800 Da.

In embodiments, the polyether polyol also may comprise the addition reaction product of an alkylene oxide with an active hydrogen initiator, wherein
the alkylene oxide comprises ethylene oxide, propylene oxide, butylene oxide, isobutylene oxide, N-hexyl oxide, styrene oxide, trimethylene oxide, epichlorohydrin, or any combination thereof, and
the active hydrogen initiator comprises glycerin, triethanolamine, trimethyolpropane (TMP), or any combination thereof.

Other polyether polyols which can be used in the second reaction composition are disclosed in U.S. Patent Appl. Publ. No. 2018/0072846, which is incorporated herein by reference in its entirety.

Catalyst. The second reaction composition (B-side) can also comprise a polyurethane producing catalyst. The catalyst can be any suitable catalyst known in the art as appropriate for use in the manufacture of polyurethane foams from the disclosed components. For example, in one aspect, the polyurethane producing catalyst can comprise or can be selected from an amine compound. In an aspect, the polyurethane producing catalyst can comprise or can be selected from a primary amine compound, a secondary amine compound, a tertiary amine compound, a quaternary ammonium salt, or a radical forming agent.

In embodiments, the polyurethane producing catalyst can comprise or can be selected from Polycat® 15, Polycat® 37, Jeffcat® ZF 20, Jeffcat® Z-130, Jeffcat® LE 30, Dabco® T, Tetramethylguanidine, Dimethylaminopropylamine, Polycat® 30, Polycat® 31, Polycat® 37, Diethanolamine, Triethanolamine, Polycat® 142, Polycat® 141, Dabco® NE300, Dabco® NE310, Toyocat® D60, Dimethylaminoethanol, Jeffcat® ZF-10, Jeffcat® ZR-50, Niax® A-99, or any combination thereof.

In an aspect, the polyurethane producing catalyst can be present in the second reaction composition (B-side) in a concentration of from about 4 wt % to about 12 wt % in the second reaction composition (B-side). Therefore, the catalyst concentration of the polyurethane foams of this disclosure can be higher than, including outside the range of, the catalyst concentrations used for the production of packaging foams. In another aspect, the polyurethane producing catalyst can be present in the second reaction composition (B-side) in a concentration of from about 5 wt % to about 11 wt %, or alternatively from about 6 wt % to about 10 wt %, including any sub-ranges and combinations of sub-ranges encompassed in these ranges. In still a further aspect, the polyurethane producing catalyst can be present in the second reaction composition (B-side) in a concentration of about 4.0 wt %, about 4.5 wt %, about 5.0 wt %, about 5.5 wt %, about 6.0 wt %, about 6.5 wt %, about 7.0 wt %, about 7.5 wt %, about 8.0 wt %, about 8.5 wt %, about 9.0 wt %, about 9.5 wt %, about 10.0 wt %, about 10.5 wt %, about 11.0 wt %, about 11.5 wt %, or about 12.0 wt %, or any ranges or combinations of ranges between any of these values.

Flame Retardant. The second reaction composition (B-side) can also comprise a flame retardant, and any flame retardant suitable for use in polyurethane foams can be used. In one aspect, for example, the flame-retardant can comprise or can be selected from a phosphate compound, a halogenated compound, a non-halogenated compound, or a combination thereof. For example, in an aspect, the flame-retardant can comprise or can be selected from a chlorinated compound, a brominated compound, an iodinated compound, a non-halogenated compound, or a combination thereof.

In an aspect, the flame retardant can comprise or can be selected from a halogenated compound selected from tris(2-chloroisopropyl)phosphate (TCPP), tris(1,3-dichloroisopropyl)-phosphate (TDCPP), tris (2-chloroethyl) phosphate (TCEP), PHT 4-Diol (tetrabromophthalate diol), PHT 4-Diol LV (tetrabromophthalate diol, low viscosity), Saytex® RB79, Saytex® RB7980, Ixol® B-251, Ixol® M-125, SaFRon® 6605, or any combination thereof. The flame retardant also can comprise or can be selected from a non-halogenated compound selected from triethylphosphate, melamine, ammonium polyphosphate, VeriQuel® R100, pentaerythritol, sorbitol, xylitol, magnesium hydroxide, aluminum hydroxide, or any combination thereof.

In another aspect, the flame-retardant can comprise or can be selected from a brominated compound such as an aryl-brominated polyester polyol, a brominated aliphatic compound, a brominated benzoate compound, a brominated phthalate compound, a polybrominated diphenylether, a polybrominated biphenyl, or any combination thereof. The flame-retardant component can also comprise or can be selected from a brominated compound such as dibromoneopentyl glycol, tribromoneopentyl alcohol, n-propyl bromide, bis-[dibromopropoxydibromophenyl]propane, hexabromodecane, bis(tribromophenoxy)ethane, or any combination thereof.

In an aspect of the polyurethane foam and the process for making a polyurethane foam, the flame retardant can be present in the second reaction composition (B-side) in a concentration of from about 4 wt % to about 42 wt %, alternatively from about 10 wt % to about 40 wt %, alternatively from about 20 wt % to about 40 wt %, alternatively from about 15 wt % to about 30 wt %, including any sub-ranges and combinations of sub-ranges encompassed in these ranges. In still a further aspect, the flame retardant can be present in the second reaction composition in a concentration of about 4 wt %, about 5 wt %, about 6 wt %, about 8 wt %, about 10 wt %, about 12 wt %, about 14 wt %, about 16 wt %, about 18 wt %, about 20 wt %, about 22 wt %, about 24 wt %, about 25 wt %, about 26 wt %, about 28 wt %, about 30 wt %, about 32 wt %, about 34 wt %, about 36 wt %, about 38 wt %, about 40 wt %, or about 42 wt %, or any ranges or combinations of ranges between any of these values.

The flame retardant can be used in an amount is sufficient to meet or exceed the test standards set forth in ASTM E-84 flame spread and smoke indices. The polyurethane foam disclosed herein can meet or exceed a variety of other tests such as flame retardant tests, ignition barrier tests, thermal barrier tests, as disclosed hereinbelow.

Surfactant. The second reaction composition (B-side) can also comprise one or more surfactants, which are compatible with the components used to make the disclosed foams. In an aspect, for example the surfactant component can comprise or can be selected from a non-ionic surfactant, a silicone surfactant, a non-silicone non-ionic surfactant, an organic surfactant, or a combination thereof.

In an aspect of the polyurethane foam and the process for making a polyurethane foam, the surfactant component can be present in the second reaction composition (B-side) in a concentration from about 0.05 wt % to about 6 wt %, alternatively from about 0.1 wt % to about 5 wt %, alternatively from about 0.5 wt % to about 4 wt %, or alternatively from about 1 wt % to about 3 wt % of the second reaction composition, including any sub-ranges and combinations of sub-ranges encompassed in these ranges. In an aspect, these concentration numbers do not include the compatiblizer surfactant component, which are considered hereinbelow. When the optional compatiblizer is present in the second reaction composition along with the surfactant component, the total concentration of surfactant and compatiblizer can be the additive concentrations of the surfactant and compatiblizer recited herein, even when both the surfactant and the compatiblizing agent are, for example, a non-ionic surfactant.

In embodiments, the surfactant component can be present in the second reaction composition (B-side) in a concentration of about 0.05 wt %, 0.1 wt %, about 0.25 wt %, about 0.5 wt %, about 0.75 wt %, about 1.0 wt %, about 1.5 wt %, about 2.0 wt %, about 2.5 wt %, about 3.0 wt %, about 3.5 wt %, about 4.0 wt %, about 4.5 wt %, about 5.0 wt %, about 5.5 wt %, or about 6.0 wt %, or any ranges or combinations of ranges between any of these values.

In some aspects, the surfactant in the second reaction composition can comprise or can be selected from an alkoxylation product of a fatty acid, a fatty acid ester, a fatty acid amide, an aliphatic alcohol, an aliphatic polyol, a sugar, or a sugar alcohol. In embodiments, the surfactant in the second reaction composition (B-side) can comprise or can be selected from a sorbitan ester, a polyethoxylated sorbitan ester, a polyoxyethylene glycol alkyl ether, a polyoxypropylene glycol alkyl ether, a glucoside alkyl ether, a polyoxyethylene glycol octylphenol ether, a polyoxyethylene glycol alkylphenol ether, a polyoxyethylene glycol sorbitan alkyl ester, a sorbitan alkyl ester, or a combination thereof. In other aspects, the surfactant in the second reaction composition (B-side) can comprise or can be selected from oxyethylated alkylphenols, oxyethylated fatty alcohols, paraffin oils, castor oil esters, ricinoleic acid esters, or fatty alcohols.

According to another aspect, the first reaction composition (A-side) can further comprise a surfactant, in addition to the polyisocyanate component. Therefore, while the first reaction composition (A-side) can consist of or can consists essentially of the polyisocyanate component, in embodiments, the first reaction composition can comprise a surfactant, in a concentration up to about 5 wt % of the first reaction composition. In this aspect, the surfactant that can be used in the first reaction composition can be a non-ionic surfactant, a silicone surfactant, a non-silicone non-ionic surfactant, or a combination thereof. In this aspect, the surfactant that can be used in the first reaction composition can be any of the surfactants used in the second reaction composition (B-side).

In an aspect, the surfactant in the second reaction composition (B-side) can comprise or can be selected from a non-ionic surfactant such as Surfonic® N95, Tergitol® NP9, Ecosurf® SA9, Surfonic® CO-25, Surfonic® ME400-CO, Surfonic® N120, Ecosurf® SA7, Ecosurf® SA4, Surfonic® ME550, or any combination thereof. In another aspect, the surfactant in the second reaction composition (B-side) can comprise or can be selected from a silicone surfactant such as Silstab® 2760, Silstab® 2780, Silstab® 2550, Niax® L-6189, Vorasurf™ DC 198, Niax® L-5388, Niax® L-5345, Dabco® 198, Niax® Y16312, Niax® L-6186, Niax® L-6972, Niax® L-6884, Niax® L-5388, Silstab® 2755, Tegostab® B-8580, Tegostab® B-8870, or any combination thereof. According to a further aspect, the surfactant in the second reaction composition (B-side) can comprise or can be selected from an organic surfactant such as Dabco® LK443, Dabco® LK221, Vorsurf® 504, or any combination thereof.

Compatiblizer. According to an aspect of this disclosure, the second reaction composition (B-side) can further optionally comprise a “compatiblizer” or a “compatiblizing agent”, in addition to the surfactant component described above. The compatiblizer can comprise or can be selected from a non-ionic surfactant, a non-silicone non-ionic surfactant, or a combination thereof.

In an aspect, there is substantial overlap between the surfactants used in the surfactant component and the surfactants used in the optional compatiblizing agent component of the second reaction mixture, and a surfactant selected for one function can serve both functions. In one aspect, the compatiblizer can function to “compatiblize” the first reaction component and the mixture of chemicals in the second reaction component, so that the polyurethane forming reaction proceeds smoothly.

In embodiments, examples of compatibilizing agents that can be used in the second reaction composition include, but are not limited to, non-ionic surfactants such as Surfonic® N95, Tergitol® NP9, Ecosurf® SA9, Surfonic® CO-25, Surfonic® ME400-CO, Surfonic® N120, Ecosurf® SA7, Ecosurf® SA4, Surfonic® ME550, or any combination thereof.

In an aspect of the polyurethane foam and the process for making a polyurethane foam, the compatiblizer component can be present in the second reaction composition (B-side) in a concentration of from 0 wt % as it is an optional component. In another aspect, the compatiblizer component can be present in the second reaction composition in a concentration of from 0 wt % to about 22 wt %, alternatively from about 0 wt % to about 20 wt %, alternatively from about 2 wt % to about 20 wt %, alternatively from about 5 wt % to about 20%, alternatively from about 10 wt % to about 20 wt %, or alternatively from about 12 wt % to about 17 wt %, including any sub-ranges and combinations of sub-ranges encompassed in these ranges. In embodiments, the compatiblizer component can be present in the second reaction composition (B-side) in a concentration of 0 wt % or about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, or about 22 wt %, or any ranges or combinations of ranges between any of these values.

In an aspect, these concentration numbers do not include the surfactant component described previously. When the optional compatiblizer is present in the second reaction composition along with the surfactant component, the total concentration of surfactant and compatiblizer can be the additive concentrations of the surfactant and compatiblizer recited herein. In this aspect, the combined concentration of the surfactant component and the compatiblizer component which can be present in the second reaction composition (B-side) can be the additive concentrations of the surfactant and compatiblizer recited herein, even when there is a single component such as a single non-ionic surfactant in the second reaction composition which functions as both surfactant component and the compatiblizer component.

Water. The second reaction composition (B-side) can also comprise water as a blowing agent. In an aspect of the polyurethane foam and the process for making a polyurethane foam, the water can be present in the second reaction composition in a concentration of from about 15 wt % to about 55 wt %, alternatively from about 20 wt % to about 50 wt %, alternatively from about 25 wt % to about 45 wt %, or alternatively from about 30 wt % to about 40 wt %, including any sub-ranges and combinations of sub-ranges encompassed in these ranges. According to a further aspect, the water can be present in the second reaction composition in a concentration of about 15 wt %, about 20 wt %, about 25 wt %, about 30 wt %, about 35 wt %, about 40 wt %, about 45 wt %, about 50 wt %, or about 55 wt %, or any ranges or combinations of ranges between any of these values.

Other Components. The second reaction composition (B-side) can also comprise a number of other components that may be considered optional components, because embodiments are known in which any or all of these other components are absent, and embodiments are known in which any or all of these other components are present. Various optional components are well understood by the person of ordinary skill in the art.

In an aspect for example, optional components include but are not limited to, a plasticizer, an emulsifier, a biocide, a bacteriostat, a filler, a dye or colorant, an anti-scorching agent, a cross-linker, an antioxidant, an antistatic agent, a stabilizing agent, a cell-opening agent, or any combination thereof.

For example, the second reaction composition can comprise a stabilizing agent which imparts rigidity to the foam. For example, the stabilizing agent can comprise a glycerin/sucrose-initiated polyether polyol such as Carpol® GSP 520, in which the high functionality of the initiators yields a resultant polyol with a nominal functionality of five and a typical Hydroxyl Number of 520. In another aspect for example, the second reaction composition can comprise a stabilizing agent selected from an alkoxylated sucrose-glycerin based polyol, alkoxylated sucrose-glycerin amine based polyol, alkoxylated sucrose-diethylene glycol based polyol, alkoxylated sucrose-amine based polyol, alkoxylated amine based polyol, a Mannich based alkoxylated polyol, triethanolamine, diethanolamine, or 2-methyl-2,4-pentanediol.

In an aspect, for example, the second reaction composition (B-side) used to make the polyurethane form can comprise a plasticizer. In another aspect, the plasticizer can comprise or can be selected from a phthalate plasticizer, a phosphate or phosphorus-containing plasticizer, or a benzoate plasticizer. In some aspects, the flame retardant compounds can comprise or can be selected from a phosphate compound, and the phosphate compound can exhibit plasticizing properties. In another aspect, for example, the first reaction composition (A-side) used to make the polyurethane form can comprise a plasticizer. For example, the optional plasticizer which can be used in the first reaction composition can comprise or can be selected from a phthalate plasticizer, a phosphate or phosphorus-containing plasticizer, or a benzoate plasticizer.

Process Parameters. In one aspect of the disclosure, the first reaction composition (A-side) and the second reaction composition (B-side) are used in “off-ratio” A-side:B-side volume ratios (v:v), which uses a higher volume of A-side than the volume of B-side and therefore which departs from the roughly 1:1 (v:v) ratio common in conventional spray polyurethane foams. Therefore, according to an aspect, the first reaction composition (A-side) and the second reaction composition (B-side) are used in amounts to provide an A-side:B-side volume ratio (v:v) of from about 1.2:1 to about 2.0:1. In other aspects, the first reaction composition (A-side) and the second reaction composition (B-side) are used in amounts to provide an A-side:B-side volume ratio (v:v) of from about 1.2:1 to about 1.9:1, alternatively from about 1.25:1 to about 1.75:1, alternatively from about 1.3:1 to about 1.6:1, or alternatively from about 1.3:1 to about 1.55:1, including any sub-ranges and combinations of sub-ranges encompassed in these ranges. In an aspect, the A-side:B-side volume ratio (v:v) can be about 1.2, about 1.3, about 1.4, about 1.5, about 1.6, about 1.7, about 1.8, about 1.9, or about 2.0, or any ranges or combinations of ranges between any of these values.

According to a further aspect, the process can be carried out using amounts of the A-side components and the B-side components to provide an Isocyanate Index (ISO Index) that is from about 20 to about 40 (expressed as a percentage). According to another aspect, the disclosed process can be carried out using amounts of the A-side components and the B-side components to provide an Isocyanate Index (ISO Index) from about 20 to about 35; alternatively, from about 22 to about 32; or alternatively, from about 20 to about 30, all expressed as a percentage, or any sub-ranges and combinations of sub-ranges encompassed in these ranges. For example, in an aspect, the Isocyanate Index (expressed as a percentage) can be about 20, about 21, about 22, about 23, about 24, about 25, about 26, about 27, about 28, about 29, about 30, about 31, about 32, about 33, about 34, about 35, about 36, about 37, about 38, about 39, or about 40, or any ranges or combinations of ranges between any of these values.

According to an aspect, the components used to make the foams of this disclosure may be used with high pressure systems, and the resulting foams may be referred to as high pressure polyurethane foams. For example, spray foam systems which can be used in producing the disclosed foams include those with proportioners dispensing at a pressure of from 500 psi (pounds per square inch) to 2,000 psi, alternatively from 750 psi to 1,750 psi, or alternatively from 1,000 psi to 1,500 psi, including any sub-ranges and combinations of sub-ranges encompassed in these ranges. Pressures outside these ranges are possible, for example, the proportioners can be used at a pressure of up to about 2,500 psi. For example, the proportioners can be used to dispense at a pressures of about 500 psi, about 550 psi, about 600 psi, about 650 psi, about 700 psi, about 750 psi, about 800 psi, about 850 psi, about 900 psi, about 950 psi, about 1,000 psi, about 1,050 psi, about 1,100 psi, about 1,150 psi, about 1,200 psi, about 1,250 psi, about 1,300 psi, about 1,350 psi, about 1,400 psi, about 1,450 psi, about 1,500 psi, about 1,550 psi, about 1,600 psi, about 1,650 psi, about 1,700 psi, about 1,750 psi, about 1,800 psi, about 1,850 psi, about 1,900 psi, about 1,950 psi, or about 2,000 psi, or any ranges or combinations of ranges between any of these values.

In a further aspect, contacting of the first reaction composition (A-side) and the second reaction composition (B-side) can occur at a temperature of from about 100° F. to about 160° F., alternatively from about 110° F. to about 150° F., or alternatively from about 120° F. to about 140° F., including any sub-ranges and combinations of sub-ranges encompassed in these ranges. For example, contacting of the first reaction composition (A-side) and the second reaction composition (B-side) can occur at a temperature of about 100° F., about 110° F., about 120° F., about 130° F., about 140° F., about 150° F., or about 160° F., or any ranges or combinations of ranges between any of these values.

Foam Properties. In addition to the properties of the resulting foam disclosed herein, the flame-retardant polyurethane (PUR) foam prepared as described herein can have density from about 0.25 lb/ft³ to about 0.45 lb/ft³, alternatively from about 0.27 lb/ft³ to about 0.42 lb/ft³, or alternatively from about 0.28 lb/ft³ to about 0.40 lb/ft³, including any sub-ranges and combinations of sub-ranges encompassed in these ranges. In a further aspect, the flame-retardant polyurethane (PUR) foam prepared as described herein can have density of about 0.25 lb/ft³, about 0.26 lb/ft³, 0.27 lb/ft³, 0.28 lb/ft³, 0.29 lb/ft³, 0.30 lb/ft³, 0.31 lb/ft³, 0.32 lb/ft³, 0.33 lb/ft³, 0.34 lb/ft³, 0.35 lb/ft³, 0.36 lb/ft³, 0.37 lb/ft³, 0.38 lb/ft³, 0.39 lb/ft³, 0.40 lb/ft³, 0.41 lb/ft³, 0.42 lb/ft³, 0.43 lb/ft³, 0.44 lb/ft³, or 0.45 lb/ft³, or any ranges or combinations of ranges between any of these values.

The polyurethane foam according to this disclosure can exhibit good fire and flame retardant and thermal insulation properties, and good air sealing and sound abatement properties. For example, the polyurethane foam of this disclosure can be formed into a barrier layer having an R-value of from about 3.2 ft²·° F.·h/BTU·in to about 4.2 ft²·° F.·h/BTU·in, or alternatively from about 3.6 ft²·° F.·h/BTU·in to about 4.0 ft²·° F.·h/BTU·in, in accordance with ASTM C-518, including any sub-ranges and combinations of sub-ranges encompassed in these ranges. In an aspect, for example, the polyurethane foam of this disclosure can be formed into a barrier layer having an R-value of about 3.2 ft²·° F.·h/BTU·in, about 3.3 ft²·° F.·h/BTU·in, about 3.4 ft²·° F.·h/BTU·in, about 3.5 ft²·° F.·h/BTU·in, about 3.6 ft²·° F.·h/BTU·in, about 3.7 ft²·° F.·h/BTU·in, about 3.8 ft²·° F.·h/BTU·in, about 3.9 ft²·° F.·h/BTU·in, about 4.0 ft²·° F.·h/BTU·in, about 4.1 ft²·° F.·h/BTU·in, or about 4.2 ft²·° F.·h/BTU·in, including any ranges between any of these values.

In an aspect, the polyurethane foam of this disclosure can also meet or exceed the requirements for Surface Burning Characteristics in accordance with ASTM E-84 of ≤75 Flame Spread Index and ≤450 Smoke Developed Index, or alternatively, ≤25 Flame Spread Index and ≤450 Smoke Developed Index.

According to another aspect, the polyurethane foam of this disclosure can meet or exceed the requirements for omission of the code-prescribed ignition barrier in accordance with the International Code Council Evaluation Services Acceptance Criteria for Spray Polyurethane Foam, AC-377.

In a further aspect, the polyurethane foam of this disclosure can meet or exceed the requirements for omission of the code-prescribed ignition barrier by way of special end use configuration testing in accordance with the International Residential Code, Chapter 3 and the International Building Code, Chapter 26. The polyurethane foam of this disclosure can also meet or exceed the requirements for omission of the code-prescribed thermal barrier by way of special end use configuration testing in accordance with the International Residential Code, Chapter 3 and the International Building Code, Chapter 26.

In yet another aspect, the polyurethane foam of this disclosure can meet or exceed the requirements for air impermeable insulation in accordance with ASTM E-2178.

The polyurethane foam of this disclosure also can meet or exceed the requirements for physical properties in accordance with the International Code Council Evaluation Services Acceptance Criteria for Spray Polyurethane Foam, AC-377, Table 1.

These and other aspects and embodiments are provided in the examples below.

### EXAMPLES

The following examples are not intended to be limiting, but rather representative of the various embodiments and aspects of the disclosure. The foams produced in these examples are generated using different volumetric ratios of the first reaction composition (A-side) to the second reaction composition (B-side), therefore providing different NCO indices, as shown.

In addition to the ranges of weight percentages of components set out above, for each of the Examples provided herein, variations are possible for each reported mass of each component in Tables 1-5. For example, in Table 1-5, the mass of the flame retardant tris(2-chloroisopropyl)-phosphate (TCPP) in the B-side component (resin) can vary from 20 wt % to 30 wt %, which is relative to the other components in the B-side. In an aspect, the relative mass of each component in the Tables can vary, independently, by about ±1% of the reported relative mass, about ±3% of the reported relative mass, about ±5% of the reported relative mass, about ±10% of the reported relative mass, or about ±15% of the reported relative mass. As an example, where the TCPP relative mass in the B-side component is 20.00, this relative mass can vary independently of the other components, ±10% of the reported relative mass. Therefore the TCPP relative mass can be from 18.00 to 22.00 (20.00±5.5). This variation in the relative mass of TCPP can be independent of the variation in the relative mass of the other components recited in these examples and tables, and this variation is an additional way in which the Examples can vary, in addition to the ranges of weight percentages of components set out in the detailed description above.

In these Examples, OHV is the Hydroxyl Value (Hydroxyl Number), Eq. Wt. is equivalent weight, PBW is the Percent By Weight (wt %), and Eq. is the number of equivalents. The “Resin Component” corresponds to the second reaction composition (B-side), and the “Isocyanate Component” corresponds to the first reaction composition (A-side).

### Example 1

The following table provides the listing of the components of the first reaction composition (A-side) comprising a polyisocyanate and the second reaction composition (B-side) comprising the polyether polyol for this example. In this example, the polyurethane (PUR) foam is produced using an A-side:B-side volumetric ratio of 1.20:1 and an NCO Index of 30.03.

TABLE 1
Components and process for preparing
the Example 1 polyurethane foam

| Resin Component | OHV | Eq. Wt. | PBW | Eq. |
|---|---|---|---|---|
| Carpol GP 4520 | 36 | 1558 | 20.00 | 0.0128 |
| Silstab 2760 | 30 | 1870 | 1.50 | 0.0008 |
| Polycat 15 | 299 | 188 | 8.00 | 0.0426 |
| TCPP | | | 25.00 | |
| Tergitol NP9 | 88 | 638 | 15.50 | 0.0243 |
| Water | 6233 | 9 | 30.00 | 3.3332 |
| Total | | | 100.00 | 3.4137 |
| Resin Specific Gravity | | | 1.08 | |
| Isocyanate Specific Gravity | | | 1.24 | |
| A/B Volumetric Ratio | | | 1.20 | |
| A/B Mass Ratio | | | 1.38 | |

| Isocyanate Component | % NCO | Eq. Wt. | PBW | Eq. |
|---|---|---|---|---|
| Wannate PM200 | 31.25 | 134 | 137.78 | 1.0251 |
| NCO Index, % | | | 30.03 | |
| Cup Mix Density, lbs/ft³ | | | 0.41 | |

### Example 2

The following table provides the listing of the components of the first reaction composition (A-side) comprising a polyisocyanate and the second reaction composition (B-side) comprising the polyether polyol for this example. In this example, the polyurethane (PUR) foam is produced using an A-side:B-side volumetric ratio of 2.00:1 and an NCO Index of 37.73%.

TABLE 2
Components and process for preparing
the Example 2 polyurethane foam

| Resin Component | OHV | Eq. Wt. | PBW | Eq. |
|---|---|---|---|---|
| Pluracol 816 | 35 | 1603 | 13.00 | 0.0081 |
| Tegostab B 8870 | 30 | 1870 | 2.50 | 0.0013 |
| Jeffcat ZF 10 | 295 | 190 | 2.00 | 0.0105 |
| Jeffcat Z 130 | 299 | 188 | 5.50 | 0.0293 |
| Jeffcat ZR 50 | 229 | 245 | 3.50 | 0.0143 |
| TCPP | | | 20.00 | |
| Tergitol NP9 | 88 | 638 | 13.50 | 0.0212 |
| Water | 6233 | 9 | 40.00 | 4.4442 |
| Total | | | 100.00 | 4.5289 |
| Resin Specific Gravity | | | 1.08 | |
| Isocyanate Specific Gravity | | | 1.24 | |
| A/B Volumetric Ratio | | | 2.00 | |
| A/B Mass Ratio | | | 2.30 | |

| Isocyanate Component | % NCO | Eq. Wt. | PBW | Eq. |
|---|---|---|---|---|
| Wannate PM200 | 31.25 | 134 | 229.63 | 1.7086 |
| NCO Index, % | | | 37.73 | |
| Cup Mix Density, lbs/ft³ | | | 0.35 | |

### Example 3

The following table provides the listing of the components of the first reaction composition (A-side) comprising a polyisocyanate and the second reaction composition (B-side) comprising the polyether polyol for this example. In this example, the polyurethane (PUR) foam is produced using an A-side:B-side volumetric ratio of 1.50:1 and an NCO Index of 32.79%.

TABLE 3
Components and process for preparing
the Example 3 polyurethane foam

| Resin Component | OHV | Eq. Wt. | PBW | Eq |
|---|---|---|---|---|
| Carpol GP 4520 | 36 | 1558 | 28.00 | 0.0180 |
| Silstab 2780 | 30 | 1870 | 2.00 | 0.0011 |
| Niax A99 | | | 5.00 | |
| TCPP | | | 30.00 | |
| Water | 6233 | 9 | 35.00 | 3.8887 |
| Total | | | 100.00 | 3.9077 |
| Resin Specific Gravity | | | 1.08 | |
| Isocyanate Specific Gravity | | | 1.24 | |
| A/B Volumetric Ratio | | | 1.50 | |
| A/B Mass Ratio | | | 1.72 | |

| Isocyanate Component | % NCO | Eq. Wt. | PBW | Eq |
|---|---|---|---|---|
| Wannate PM200 | 31.25 | 134 | 172.22 | 1.2814 |
| NCO Index, % | | | 32.79 | |
| Cup Mix Density, lbs/ft³ | | | 0.36 | |

### Example 4

The following table provides the listing of the components of the first reaction composition (A-side) comprising a polyisocyanate and the second reaction composition (B-side) comprising the polyether polyol for this example. In this example, the polyurethane (PUR) foam is produced using an A-side:B-side volumetric ratio of 1.75:1 and an NCO Index of 38.01%.

TABLE 4
Components and process for preparing
the Example 4 polyurethane foam

| Resin Component | OHV | Eq. Wt. | PBW | Eq |
|---|---|---|---|---|
| Carpol GP 4520 | 36 | 1558 | 19.00 | 0.0122 |
| Tegostab B 8580 | 30 | 1870 | 2.00 | 0.0011 |
| Dabco T | | | 4.00 | |
| Polycat 37 | | | 5.00 | |
| Surfonic N95 | | | 15.00 | |
| TCPP | | | 20.00 | |
| Water | 6233 | 9 | 35.00 | 3.8887 |
| Total | | | 100.00 | 3.9019 |
| Resin Specific Gravity | | | 1.08 | |
| Isocyanate Specific Gravity | | | 1.24 | |
| A/B Volumetric Ratio | | | 1.75 | |
| A/B Mass Ratio | | | 2.01 | |

| Isocyanate Component | % NCO | Eq. Wt. | PBW | Eq |
|---|---|---|---|---|
| Wannate PM700 | 31 | 135 | 200.93 | 1.4830 |
| NCO Index, % | | | 38.01 | |
| Cup Mix Density, lbs/ft³ | | | 0.40 | |

### Example 5

The following table provides the listing of the components of the first reaction composition (A-side) comprising a polyisocyanate and the second reaction composition (B-side) comprising the polyether polyol for this example. In this example, the polyurethane (PUR) foam is produced using an A-side:B-side volumetric ratio of 1.40:1 and an NCO Index of 34.36%.

TABLE 5
Components and process for preparing
the Example 5 polyurethane foam

| Resin Component | OHV | Eq. Wt. | PBW | Eq |
|---|---|---|---|---|
| Arcol 11-34 | 35 | 1603 | 15.00 | 0.0094 |
| Carpol GSP 520 | 520 | 108 | 5.00 | 0.0463 |
| Silstab 2760 | 30 | 1870 | 1.50 | 0.0008 |
| Polycat 31 | 298 | 188 | 10.00 | 0.0531 |
| TCPP | | | 20.00 | |
| PHT 4 Diol LV | 218 | 257 | 4.00 | 0.0155 |
| Tergitol NP9 | 88 | 638 | 14.50 | 0.0227 |
| Water | 6233 | 9 | 30.00 | 3.3332 |
| Total | | | 100.00 | 3.4811 |
| Resin Specific Gravity | | | 1.08 | |
| Isocyanate Specific Gravity | | | 1.24 | |
| A/B Volumetric Ratio | | | 1.40 | |
| A/B Mass Ratio | | | 1.61 | |

| Isocyanate Component | % NCO | Eq. Wt. | PBW | Eq |
|---|---|---|---|---|
| Wannate PM200 | 31.25 | 134 | 160.74 | 1.1960 |
| NCO Index, % | | | 34.36 | |
| Cup Mix Density, lbs/ft³ | | | 0.41 | |

### Example 6

A low density polyurethane foam (4-inches thick) according to Aspect 1 of this disclosure was applied to a ⅝-inch thick gypsum wallboard and analyzed in accordance with ASTM E84 Standard Test Method for Surface Burning Characteristics of Building Materials. The sample to be tested was placed in a conditioning room maintained at 70±5° F. and a relative humidity of 50±5% for a minimum of 72 hours prior to testing. The ASTM E84 test results are shown in the following table.

TABLE 6
ASTM E84 test results summary for subject polyurethane
foam and flame spread classification

| | Flame | Smoke | NFPA | IBC | IRC |
|---|---|---|---|---|---|
| Test Sample | Spread | Developed | Class | Class | Class |
| Sample 6 | 5 | 350 | A | A | A |

These ASTM E84 results provide a Flame Spread Classifications of: (1) NFPA Class A (National Fire Protection Association ANSI/NFPA No. 101, Life Safety Code Classification); (2) IBC Class A (International Building Code, Chapter 8, Interior Finishes, Section 803 Classification); and (3) IRC Class A (International Residential Code).

### Example 7

A series of test specimens of the polyurethane foam according to Aspect 1 of this disclosure were analyzed in accordance with ASTM E2178-13 Standard Test Method for Air Permeance of Building Materials. In order to determine that the fiber board substrate allowed air to pass freely at a magnitude where the resistance of air flow in the fiber-board would not affect air flow measurements taken on the test specimen, an individual piece of fiber-board was tested without the membrane applied and the Air Permeance of the fiber board was determined at 75 Pa to be 2.05 L/s·m².

Test specimens were conditioned for a minimum of 7 days at 21±1° C. and 40±5% relative humidity prior to testing. Test specimens were individually mounted on a test chamber and the airflow through each specimen determined in accordance with ASTM E 2178-13. Initial air infiltration and exfiltration tests were conducted at a test pressure of 75 Pa to determine the larger result of the two. Testing was conducted on a total of 5 specimens, the nominal thicknesses of which are provided below. The ASTM E2178 test results are shown in the following tables. Table 7 compares the air infiltration and exfiltration tests, with infiltration providing the larger values, which averaged an Air Permeance of 0.01759 L/s·m².

TABLE 7
ASTM E2178 test results summary for air permeance of test samples
at 75 Pa (L/s · m²) for infiltration versus exfiltration

| | | Air Permeance @ 75 Pa | |
|---|---|---|---|
| ASTM E2178 Test | Nominal | Infiltration | Exfiltration |
| Sample | Thickness (in) | (L/s · m²) | (L/s · m²) |
| Sample 7A | 3⅜ | 0.01962 | 0.01933 |
| Sample 7B | 3½ | 0.01633 | 0.01605 |
| Sample 7C | 3½ | 0.01921 | 0.01898 |
| Sample 7D | 3⅝ | 0.01724 | 0.01711 |
| Sample 7E | 3½ | 0.01553 | 0.01523 |

Table 8 provides the data for test results at 50 Pa, 75 Pa, and 100 Pa for air infiltration at standard conditions after re-measurement (L/s·m²).

TABLE 8
ASTM E2178 test results summary for air infiltration
at standard conditions after remeasurement (L/s · m²)

| | Air Infiltration at Standard Conditions | | | | | |
|---|---|---|---|---|---|---|
| Test | After ReMeasurement (L/s · m²) | | | | | |
| Pressure | Sample | Sample | Sample | Sample | Sample | |
| (Pa) | 7A | 7B | 7C | 7D | 7E | Average |
| 100 | 0.02085 | 0.01833 | 0.02125 | 0.02009 | 0.01754 | 0.01961 |
| 75 | 0.01881 | 0.01671 | 0.01921 | 0.01762 | 0.01551 | 0.01757 |
| 50 | 0.01676 | 0.01468 | 0.01716 | 0.01516 | 0.01347 | 0.01545 |

Air impermeable insulation is defined as insulation which allows a maximum total air leakage rate of 0.02 L/s·m² (0.004 ft³/min-ft²) when tested at a 75 Pa pressure differential. Accordingly, all samples in the table above are air impermeable in accordance with ASTM E2178. Percent difference for verification was within 10% of initial values, as specified by Sect. 8.2.8 of ASTM E2178. As required in ASTM E 2178-03, an error analysis was performed to correct for variability in the test procedure. Readings were corrected for temperature and atmospheric pressure per ASTM E 283.

### Example 8

Flammability testing of a low density open cell spray applied polyurethane foam prepared according to this disclosure, having 6 wet mils of FlameSeal IB™ intumescent coating (average 4 mils dry film thickness), was examined in accordance with ICC-ES AC377 Appendix X, Approved February 2020, Acceptance Criteria for Spray-Applied Foam Plastic Insulation using modified NFPA 286, Standard Methods of Fire Tests for Evaluating Contribution of Wall and Ceiling Interior Finish to Room Fire Growth—2019 Edition. The test room module was placed into a conditioning room for a minimum 48 hours at 73° F. and 64% relative humidity prior to testing. The temperature of the test chamber at time of testing to ICC-ES AC 377 Appendix X was 65° F. (18° C.) with 45% relative humidity.

Per ICC-ES AC377 Appendix X, the average time to failure for the following events must be greater than 4 minutes and 18 seconds: Heat Release Rate exceeds 1 MW; Average upper layer temperature exceeds 600° C. (1112° F.); Heat Flux at the floor exceeds 20 kW/m²; and Flames Exit Doorway. The following table compares the standard's definition of flashover with actual test results. Accordingly, the sample passed the ICC-ES AC377 Appendix X flammability test.

TABLE 9
ICC-ES AC377 Appendix X criteria average
time to failure standard and test results

| | Example 8 | |
|---|---|---|
| Criteria | Results | Pass/Fail |
| Peak Heat Release Rate exceeds 1 MW | 61 kW | Pass |
| Average upper layer temperature | 252° F. | Pass |
| exceeds 600° C. (1112° F.) | (122° C.) | |
| Heat Flux at the floor exceeds 20 kW/m² | 1.8811 | Pass |
| Flames exiting the doorway | Did not occur | Pass |
| Average time for above four events | Greater than 4 | Pass |
| | minutes and | |
| | 18 seconds | |
| | (>4:18) | |

Accordingly, it was concluded that FlameSeal IB Intumescent Coating applied at a 6 wet film thickness (4 dry film thickness) COMPLIES with the requirements of AC377 Appendix X for use as an alternative ignition barrier when applied to an open-cell spray applied foam insulation in accordance with Aspect 1 at 11 inches in the wall cavities, 16.5 inches in the ceiling cavities at a nominal 0.35 density.

### Example 9

Flammability testing of a low density open cell spray applied polyurethane foam prepared according to this disclosure, having 4 wet mils of IFTI DC315 intumescent coating (average 3 mils dry film thickness), was examined in accordance with ICC-ES AC377 Appendix X, Approved February 2020, Acceptance Criteria for Spray-Applied Foam Plastic Insulation using modified NFPA 286, Standard Methods of Fire Tests for Evaluating Contribution of Wall and Ceiling Interior Finish to Room Fire Growth—2019 Edition. The test room module was placed into a conditioning room for a minimum 48 hours at 73° F. and 64% relative humidity prior to testing. The temperature of the test chamber at time of testing to ICC-ES AC 377 Appendix X was 65° F. (18° C.) with 45% relative humidity.

Per ICC-ES AC377 Appendix X, the average time to failure for the following events must be greater than 4 minutes and 18 seconds: Heat Release Rate exceeds 1 MW; Average upper layer temperature exceeds 600° C. (1112° F.); Heat Flux at the floor exceeds 20 kW/m²; and Flames Exit Doorway. The following table compares the standard's definition of flashover with actual test results. Accordingly, the sample passed the ICC-ES AC377 Appendix X flammability test.

TABLE 10
ICC-ES AC377 Appendix X criteria average
time to failure standard and test results

| | Example 8 | |
|---|---|---|
| Criteria | Results | Pass/Fail |
| Peak Heat Release Rate exceeds 1 MW | 87 kW | Pass |
| Average upper layer temperature | 277.4° F. | Pass |
| exceeds 600° C. (1112° F.) | (136° C.) | |
| Heat Flux at the floor exceeds 20 kW/m² | 1.4462 | Pass |
| Flames exiting the doorway | Did not occur | Pass |
| Average time for above four events | Greater than 4 | Pass |
| | minutes and | |
| | 18 seconds | |
| | (>4:18) | |

Accordingly, it was concluded that IFTI DC315 applied at a 4 wet film thickness (3 dry film thickness) COMPLIES with the requirements of AC377 Appendix X for use as an alternative ignition barrier when applied to an open-cell spray applied foam insulation in accordance with Aspect 1 at 11 inches in the wall cavities, 16.5 inches in the ceiling cavities at a nominal 0.35 density.

### Example 10

Tests to determine the R-value of a nominal 1-inch thick foam prepared according to this disclosure were undertaken. Five samples of 90-day aged 1-inch thick specimens of sprayed foams according to Aspect 1 were examined and R-values were determined. Samples were tested at 75° F. mean temperature and determined to have an average R-value of R-3.8/inch, that is, 3.8 hr-ft²-° F./BTU/in. These data are summarized in the following table.

TABLE 11
R-value determination, with samples
tested at 75° F. mean temperature.

| | | Thermal | |
|---|---|---|---|
| | Thickness | Conductivity | Thermal Resistance |
| Sample | inches | BTU-in/hr-ft²-° F. | hr-ft²-° F./BTU-in |
| Sample 10A | 1.11 | 0.2860 | 3.9 |
| Sample 10B | 1.10 | 0.2871 | 3.8 |
| Sample 10C | 1.09 | 0.2876 | 3.8 |
| Sample 10D | 1.12 | 0.2884 | 3.9 |
| Sample 10E | 1.11 | 0.2888 | 3.9 |
| Average | 1.11 | 0.2876 | 3.8 |

### Aspects of the Disclosure

The features of the present invention set out hereinabove may further include the various aspects, statements, embodiments, and characteristics which are presented below which, for the purposes of this disclosure termed Aspects.

Aspect 1. A low density polyurethane (PUR) foam, the foam comprising the contact product of:

(a) a first reaction composition (A-side) comprising an aromatic polyisocyanate component having an isocyanate functionality of from about 2.5 to about 3.0; and

(b) a second reaction composition (B-side) comprising:
a polyether polyol characterized by a Hydroxyl Number (mg KOH/g) of from about 20 to about 45;
a polyurethane producing catalyst in a concentration of from 5 wt % to 12 wt % in the second reaction composition (B-side);
a flame retardant;
a surfactant; and
water;

wherein the first reaction composition (A-side) and the second reaction composition (B-side) are contacted in amounts to provide [1] an A-side:B-side volume ratio (v:v) of from 1.2:1 to 2:1, and [2] an Isocyanate Index of 20 to 40 (expressed as a percentage); and

the low density PUR foam has a density from about 0.25 lb/ft³ to about 0.45 lb/ft³.

Aspect 2. A process for making a low density polyurethane (PUR) foam, the process comprising the steps of contacting:

(a) a first reaction composition (A-side) comprising an aromatic polyisocyanate component having an isocyanate functionality of from about 2.5 to about 3.0; and

(b) a second reaction composition (B-side) comprising:
a polyether polyol characterized by a Hydroxyl Number (mg KOH/g) of from about 20 to about 45;
a polyurethane producing catalyst in a concentration of from 5 wt % to 12 wt % in the second reaction composition (B-side);
a flame retardant;
a surfactant; and
water;

wherein the first reaction composition (A-side) and the second reaction composition (B-side) are contacted in amounts to provide [1] an A-side:B-side volume ratio (v:v) of from 1.2:1 to 2:1, and [2] an Isocyanate Index of 20 to 40 (expressed as a percentage); and

the low density PUR foam has a density from about 0.25 lb/ft³ to about 0.45 lb/ft³.

Aspect 3. A polyurethane foam or a process for making a polyurethane foam according to any of the preceding Aspects, wherein the polyisocyanate component comprises methylene diphenyl diisocyanate (MDI), polymeric methylene diphenyl diisocyanate (PMDI), or any combination thereof.

Aspect 4. A polyurethane foam or a process for making a polyurethane foam according to any of the preceding Aspects, wherein the polyisocyanate component comprises 2,2′-methylene diphenyl diisocyanate (2,2′-MDI), 4,4′-methylene diphenyl diisocyanate (4,4′-MDI), polymeric methylene diphenyl diisocyanate (PMDI), or any combination thereof.

Aspect 5. A polyurethane foam or a process for making a polyurethane foam according to any of the preceding Aspects, wherein the polyisocyanate component comprises from about 20 wt % to about 80 wt % of methylene diphenyl diisocyanate (MDI) and from about 80 wt % to about 20 wt % of polymeric methylene diphenyl diisocyanate (polymeric MDI), or alternatively, from about 25 wt % to about 75 wt % of methylene diphenyl diisocyanate (MDI) and from about 75 wt % to about 25 wt % of polymeric methylene diphenyl diisocyanate (polymeric MDI).

Aspect 6. A polyurethane foam or a process for making a polyurethane foam according to any of the preceding Aspects, wherein the polyisocyanate component has an isocyanate functionality of from about 2.6 to about 2.9.

Aspect 7. A polyurethane foam or a process for making a polyurethane foam according to any of the preceding Aspects, wherein the polyether polyol is characterized by a Hydroxyl Number (mg KOH/g) of from about 25 to about 42, or alternatively from about 28 to about 38.

Aspect 8. A polyurethane foam or a process for making a polyurethane foam according to any of the preceding Aspects, wherein the polyether polyol is characterized by a molecular weight (weight average or number average) of from about 250 g/mol to about 6,000 g/mol, alternatively, from about 1,000 g/mol to about 5,500 g/mol, alternatively, from about 2,000 g/mol to about 5,250 g/mol, or alternatively from about 4,000 g/mol to about 5,000 g/mol.

Aspect 9. A polyurethane foam or a process for making a polyurethane foam according to any of the preceding Aspects, wherein the polyether polyol has a hydroxyl functionality of from 2 to 8; alternatively, from 2 to 6. alternatively, from 2 to 4, or alternatively, from 2 to 3.

Aspect 10. A polyurethane foam or a process for making a polyurethane foam according to any of the preceding Aspects, wherein the polyether polyol is present in the second reaction composition in a concentration of from about 10 wt % to about 50 wt %, alternatively from about 12 wt % to about 40 wt %, alternatively from about 15 wt % to about 30 wt %, or alternatively, from about 18 wt % to about 28 wt % in the second reaction composition.

Aspect 11. A polyurethane foam or a process for making a polyurethane foam according to any of the preceding Aspects, wherein the polyether polyol comprises or is selected from polyoxyethylene diols (glycols), polyoxyethylene triols, polyoxyethylene tetrols, polyoxyethylene pentols, polyoxyethylene hexols, polyoxypropylene diols (glycols), polyoxypropylene triols, polyoxypropylene tetrols, polyoxypropylene pentols, polyoxypropylene hexols, or any combination thereof, or an alkylene oxide addition product to any one or more of these polyols.

Aspect 12. A polyurethane foam or a process for making a polyurethane foam according to any of the preceding Aspects, wherein the polyether polyol comprises or is selected from polypropylene glycol, polyethylene glycol, polytetramethylene glycol, glycerol triols, polyether tetrols, polyether pentols, aliphatic amine tetrols, aromatic amine tetrols, sorbitol, trimethyolpropane (TMP), or pentaerythritol, or an alkylene oxide addition product to any one or more of these polyols.

Aspect 13. A polyurethane foam or a process for making a polyurethane foam according to any of the preceding Aspects, wherein the polyether polyol is formed from the addition of ethylene oxide, propylene oxide, or a combination thereof added simultaneously or sequentially, to at least one polyol, at least one polyether polyol, at least one polyamine, or a combination thereof.

Aspect 14. A polyurethane foam or a process for making a polyurethane foam according to any of the preceding Aspects, wherein the polyether polyol is formed from the addition of ethylene oxide, propylene oxide, or a combination thereof added simultaneously or sequentially, to an active hydrogen component selected from ethylene glycol, propylene glycol, diethylene glycol, dipropylene glycol, tripropylene glycol, trimethyolpropane (TMP), glycerol, pentaerythritol, sorbitol, sucrose, ethylenediamine, toluene diamine, or any combination thereof.

Aspect 15. A polyurethane foam or a process for making a polyurethane foam according to any of the preceding Aspects, wherein the polyether polyol is ethylene oxide terminated (having a high primary hydroxyl content), propylene oxide terminated (having a high secondary hydroxyl content), or a combination of ethylene oxide terminated and propylene oxide terminated.

Aspect 16. A polyurethane foam or a process for making a polyurethane foam according to any of the preceding Aspects, wherein the polyether polyol is formed from the addition of ethylene oxide, propylene oxide, or a combination thereof added simultaneously or sequentially, to an active hydrogen component in the presence of a catalyst comprising or selected from a metal hydroxide, a double metal cyanide catalyst, or a combination thereof.

Aspect 17. A polyurethane foam or a process for making a polyurethane foam according to any of the preceding Aspects, wherein the polyether polyol comprises or is selected from: an alkylene oxide adduct of a non-reducing sugar or a sugar derivative; an alkylene oxide adduct of phosphorus and polyphosphorus acids; an alkylene oxide adduct of polyphenols; polyols prepared from natural oils such as castor oil; an alkylene oxide adduct of a C₂ to C₆₀, C₂ to C₄₀, or C₂ to C₂₀ polyhydroxyalkane; or any combination thereof.

Aspect 18. A polyurethane foam or a process for making a polyurethane foam according to any of the preceding Aspects, wherein the polyether polyol comprises or is selected from an alkylene oxide adduct of 1,3-dihydroxypropane, 1,3-dihydroxybutane, 1,4-dihydroxybutane, 1,4-dihydroxyhexane, 1,5-dihydroxyhexane, 1,6-dihydroxyhexane, 1,2-dihydroxyoctane, 1,3-dihydroxyoctane, 1,4-dihydroxyoctane 1,6-dihydroxyoctane, 1,8-dihydroxyoctane, 1,10-dihydroxydecane, glycerol, 1,2,4-trihydroxybutane, 1,2,6-trihydroxyhexane, 1,1,1-trimethylolethane, 1,1,1-trimethylolpropane, pentaerythritol, caprolactone, polycaprolactone, xylitol, arabitol, sorbitol, mannitol, or any combination thereof.

Aspect 19. A polyurethane foam or a process for making a polyurethane foam according to any of the preceding Aspects, wherein the polyether polyol comprises the addition reaction product of an alkylene oxide with an active hydrogen initiator, wherein

the alkylene oxide comprises ethylene oxide, propylene oxide, butylene oxide, isobutylene oxide, N-hexyl oxide, styrene oxide, trimethylene oxide, epichlorohydrin, or any combination thereof, and

the active hydrogen initiator comprises glycerin, triethanolamine, trimethyolpropane (TMP), or any combination thereof.

Aspect 20. A polyurethane foam or a process for making a polyurethane foam according to any of the preceding Aspects, wherein the polyurethane producing catalyst comprises a primary amine compound, a secondary amine compound, a tertiary amine compound, a quaternary ammonium salt, or a radical forming agent.

Aspect 21. A polyurethane foam or a process for making a polyurethane foam according to any of the preceding Aspects, wherein the polyurethane producing catalyst comprises Polycat® 15, Polycat® 37, Jeffcat® ZF 20, Jeffcat® Z-130, Jeffcat® LE 30, Dabco® T, Tetramethylguanidine, Dimethylaminopropylamine, Polycat® 30, Polycat® 31, Polycat® 37, Diethanolamine, Triethanolamine, Polycat® 142, Polycat® 141, Dabco® NE300, Dabco® NE310, Toyocat® D60, Dimethylaminoethanol, Jeffcat® ZF-10, Jeffcat® ZR-50, Niax® A-99, or any combination thereof.

Aspect 22. A polyurethane foam or a process for making a polyurethane foam according to any of the preceding Aspects, wherein the polyurethane producing catalyst is present in the second reaction composition (B-side) in a concentration of from about 4 wt % to about 12 wt %, alternatively from about 5 wt % to about 11 wt %, or alternatively from about 6 wt % to about 10 wt %.

Aspect 23. A polyurethane foam or a process for making a polyurethane foam according to any of the preceding Aspects, wherein the flame-retardant comprises a phosphate compound, a halogenated compound, a non-halogenated compound, or a combination thereof.

Aspect 24. A polyurethane foam or a process for making a polyurethane foam according to any of the preceding Aspects, wherein the flame retardant comprises a halogenated compound selected from tris(2-chloroisopropyl)phosphate (TCPP), tris(1,3-dichloroisopropyl)phosphate (TDCPP), tris (2-chloroethyl) phosphate (TCEP), PHT 4-Diol (tetrabromophthalate diol), PHT 4-Diol LV (tetrabromophthalate diol, low viscosity), Saytex® RB79, Saytex® RB7980, Ixol® B-251, Ixol® M-125, SaFRon® 6605, or any combination thereof.

Aspect 25. A polyurethane foam or a process for making a polyurethane foam according to any of the preceding Aspects, wherein the flame retardant comprises a non-halogenated compound selected from triethylphosphate, melamine, ammonium polyphosphate, VeriQuel® R100, pentaerythritol, sorbitol, xylitol, magnesium hydroxide, aluminum hydroxide, or any combination thereof.

Aspect 26. A polyurethane foam or a process for making a polyurethane foam according to any of the preceding Aspects, wherein the flame-retardant comprises a brominated compound selected from an aryl-brominated polyester polyol, a brominated aliphatic compound, a brominated benzoate compound, a brominated phthalate compound, a polybrominated diphenylether, a polybrominated biphenyl, or any combination thereof.

Aspect 27. A polyurethane foam or a process for making a polyurethane foam according to any of the preceding Aspects, wherein the flame-retardant comprises a brominated compound selected from dibromoneopentyl glycol, tribromoneopentyl alcohol, n-propyl bromide, bis-[dibromopropoxydibromophenyl]propane, hexabromodecane, bis(tribromophenoxy)ethane, or any combination thereof.

Aspect 28. A polyurethane foam or a process for making a polyurethane foam according to any of the preceding Aspects, wherein the flame retardant is present in the second reaction composition in a concentration of from about 4 wt % to about 42 wt %, alternatively from about 10 wt % to about 40 wt %, alternatively from about 20 wt % to about 40 wt %, or alternatively from about 15 wt % to about 30 wt %.

Aspect 29. A polyurethane foam or a process for making a polyurethane foam according to any of the preceding Aspects, wherein the surfactant in the second reaction composition (B-side) comprises a non-ionic surfactant, a silicone surfactant, a non-silicone non-ionic surfactant, an organic surfactant, or a combination thereof.

Aspect 30. A polyurethane foam or a process for making a polyurethane foam according to any of the preceding Aspects, wherein the surfactant in the second reaction composition (B-side) comprises a non-ionic surfactant selected from Surfonic® N95, Tergitol® NP9, Ecosurf® SA9, Surfonic® CO-25, Surfonic® ME400-CO, Surfonic® N120, Ecosurf® SA7, Ecosurf® SA4, Surfonic® ME550, or any combination thereof.

Aspect 31. A polyurethane foam or a process for making a polyurethane foam according to any of the preceding Aspects, wherein the surfactant in the second reaction composition (B-side) comprises a silicone surfactant selected from Silstab® 2760, Silstab® 2780, Silstab® 2550, Niax® L-6189, Vorasurf™ DC 198, Niax® L-5388, Niax® L-5345, Dabco® 198, Niax® Y16312, Niax® L-6186, Niax® L-6972, Niax® L-6884, Niax® L-5388, Silstab® 2755, Tegostab® B-8580, Tegostab® B-8870, or any combination thereof.

Aspect 32. A polyurethane foam or a process for making a polyurethane foam according to any of the preceding Aspects, wherein the surfactant in the second reaction composition (B-side) comprises an organic surfactant selected from Dabco® LK443, Dabco® LK221, Vorsurf® 504, or any combination thereof.

Aspect 33. A polyurethane foam or a process for making a polyurethane foam according to any of the preceding Aspects, wherein the surfactant in the second reaction composition (B-side) comprises an alkoxylation product of a fatty acid, a fatty acid ester, a fatty acid amide, an aliphatic alcohol, an aliphatic polyol, a sugar, or a sugar alcohol.

Aspect 34. A polyurethane foam or a process for making a polyurethane foam according to any of the preceding Aspects, wherein the surfactant in the second reaction composition (B-side) comprises a sorbitan ester, a polyethoxylated sorbitan ester, a polyoxyethylene glycol alkyl ether, a polyoxypropylene glycol alkyl ether, a glucoside alkyl ether, a polyoxyethylene glycol octylphenol ether, a polyoxyethylene glycol alkylphenol ether, a polyoxyethylene glycol sorbitan alkyl ester, a sorbitan alkyl ester, or a combination thereof.

Aspect 35. A polyurethane foam or a process for making a polyurethane foam according to any of the preceding Aspects, wherein the surfactant in the second reaction composition (B-side) comprises an oxyethylated alkylphenol, an oxyethylated fatty alcohol, a paraffin oil, a castor oil ester, a ricinoleic acid ester, or a fatty alcohol.

Aspect 36. A polyurethane foam or a process for making a polyurethane foam according to any of the preceding Aspects, wherein the surfactant is present in the second reaction composition in a concentration from about 0.05 wt % to about 6 wt %, alternatively from about 0.1 wt % to about 5 wt %, alternatively from about 0.5 wt % to about 4 wt %, or alternatively from about 1 wt % to about 3 wt % of the second reaction composition.

Aspect 37. A polyurethane foam or a process for making a polyurethane foam according to any of the preceding Aspects, wherein the first reaction composition (A-side) further comprises a surfactant.

Aspect 38. A polyurethane foam or a process for making a polyurethane foam according to any of the preceding Aspects, wherein the first reaction composition (A-side) further comprises a non-ionic surfactant, a silicone surfactant, a non-silicone non-ionic surfactant, or a combination thereof.

Aspect 39. A polyurethane foam or a process for making a polyurethane foam according to any of the preceding Aspects, wherein the first reaction composition (A-side) further comprises a non-ionic surfactant selected from Surfonic® N95, Tergitol® NP9, Ecosurf® SA9, Surfonic® CO-25, Surfonic® ME400-CO, Surfonic® N120, Ecosurf® SA7, Ecosurf® SA4, Surfonic® ME550, or any combination thereof.

Aspect 40. A polyurethane foam or a process for making a polyurethane foam according to any of the preceding Aspects, wherein the surfactant in the first reaction composition (A-side) comprises a silicone surfactant selected from Silstab® 2760, Silstab® 2780, Silstab® 2550, Niax® L-6189, Vorasurf™ DC 198, Niax® L-5388, Niax® L-5345, Dabco® 198, Niax® Y16312, Niax® L-6186, Niax® L-6972, Niax® L-6884, Niax® L-5388, Silstab® 2755, Tegostab® B-8580, Tegostab® B-8870, or any combination thereof.

Aspect 41. A polyurethane foam or a process for making a polyurethane foam according to any of the preceding Aspects, wherein the first reaction composition (A-side) consists essentially of the polyisocyanate component.

Aspect 42. A polyurethane foam or a process for making a polyurethane foam according to any of the preceding Aspects, wherein the first reaction composition (A-side) comprises the polyisocyanate component in a concentration of at least about 95 wt % of the first reaction composition.

Aspect 43. A polyurethane foam or a process for making a polyurethane foam according to any of the preceding Aspects, wherein the second reaction composition (B-side) further comprises a compatiblizing agent.

Aspect 44. A polyurethane foam or a process for making a polyurethane foam according to any of the preceding Aspects, wherein the second reaction composition (B-side) further comprises a compatiblizing agent selected from a non-ionic surfactant, a non-silicone non-ionic surfactant, or a combination thereof.

Aspect 45. A polyurethane foam or a process for making a polyurethane foam according to any of the preceding Aspects, wherein the second reaction composition (B-side) further comprises a compatibilizing agent selected from Surfonic® N95, Tergitol® NP9, Ecosurf® SA9, Surfonic® CO-25, Surfonic® ME400-CO, Surfonic® N120, Ecosurf® SA7, Ecosurf® SA4, Surfonic® ME550, or any combination thereof.

Aspect 46. A polyurethane foam or a process for making a polyurethane foam according to any of the preceding Aspects, wherein the compatibilizing agent is present in the second reaction composition (B-side) in a concentration of from about 2 wt % to about 20 wt %, alternatively from about 5 wt % to about 20%, alternatively from about 10 wt % to about 20 wt %, or alternatively from about 12 wt % to about 17 wt % in the second reaction composition.

Aspect 47. A polyurethane foam or a process for making a polyurethane foam according to any of the preceding Aspects, wherein the water is present in the second reaction composition (B-side) in a concentration of from about 15 wt % to about 55 wt %, alternatively from about 20 wt % to about 50 wt %, alternatively from about 25 wt % to about 45 wt %, or alternatively from about 30 wt % to about 40 wt %.

Aspect 48. A polyurethane foam or a process for making a polyurethane foam according to any of the preceding Aspects, wherein the second reaction composition further comprises any one or more of a plasticizer, an emulsifier, a biocide, a bacteriostat, a filler, a dye or colorant, an anti-scorching agent, a cross-linker, an antioxidant, an antistatic agent, an stabilizing agent, or a cell-opening agent.

Aspect 49. A polyurethane foam or a process for making a polyurethane foam according to any of the preceding Aspects, wherein the second reaction composition further comprises a plasticizer selected from a phthalate plasticizer, a phosphate or phosphorus-containing plasticizer, or a benzoate plasticizer.

Aspect 50. A polyurethane foam or a process for making a polyurethane foam according to any of the preceding Aspects, wherein the second reaction composition further comprises a stabilizing agent comprising a glycerin/sucrose-initiated polyether polyol, an alkoxylated sucrose-glycerin based polyol, alkoxylated sucrose-glycerin amine based polyol, alkoxylated sucrose-diethylene glycol based polyol, alkoxylated sucrose-amine based polyol, alkoxylated amine based polyol, a Mannich based alkoxylated polyol, triethanolamine, diethanolamine, or 2-methyl-2,4-pentanediol.

Aspect 51. A polyurethane foam or a process for making a polyurethane foam according to any of the preceding Aspects, wherein the first reaction composition further comprises a plasticizer selected from a phthalate plasticizer, a phosphate or phosphorus-containing plasticizer, or a benzoate plasticizer.

Aspect 52. A polyurethane foam or a process for making a polyurethane foam according to any of the preceding Aspects, wherein the second reaction composition further comprises a cross-linker selected from a propoxylated sucrose-glycerin based polyol.

Aspect 53. A polyurethane foam or a process for making a polyurethane foam according to any of the preceding Aspects, wherein the contacting occurs at high pressure by plural component dispensing at a pressure of from 500 psi (pounds per square inch) to 2,000 psi, alternatively from 750 psi to 1,750 psi, or alternatively from 1,000 psi to 1,500 psi.

Aspect 54. A polyurethane foam or a process for making a polyurethane foam according to any of the preceding Aspects, wherein the contacting occurs by plural component dispensing at a temperature of from 100° F. to 160° F.; alternatively, from 110° F. to 150° F.; or alternatively, from 120° F. to 140° F.

Aspect 55. A polyurethane foam or a process for making a polyurethane foam according to any of the preceding Aspects, wherein the first reaction composition (A-side) and the second reaction composition (B-side) are used in amounts to provide an A-side:B-side volume ratio (v:v) of from about 1.2:1 to about 1.9:1, alternatively from about 1.25:1 to about 1.75:1, alternatively from about 1.3:1 to about 1.6:1, or alternatively from about 1.3:1 to about 1.55:1.

Aspect 56. A polyurethane foam or a process for making a polyurethane foam according to any of the preceding Aspects, wherein the first reaction composition and the second reaction composition are used in amounts to provide an Isocyanate Index (as a percentage) from 20 to 35; alternatively, from 22 to 32; or alternatively, from 20 to 30.

Aspect 57. A polyurethane foam or a process for making a polyurethane foam according to any of the preceding Aspects, wherein the polyurethane foam has a density from about 0.27 lb/ft³ to about 0.42 lb/ft³, or alternatively from about 0.28 lb/ft³ to about 0.40 lb/ft³.

Aspect 58. A polyurethane foam or a process for making a polyurethane foam according to any of the preceding Aspects, wherein the polyurethane foam is formed into a barrier layer having an R-value of from 3.2 ft²·° F.·h/BTU·in to 4.2 ft²·° F.·h/BTU·in, or alternatively, from 3.6 ft²·° F.·h/BTU·in to 4.0 ft²·° F.·h/BTU·in, in accordance with ASTM C-518.

Aspect 59. A polyurethane foam or a process for making a polyurethane foam according to any of the preceding Aspects, wherein the polyurethane foam meets or exceeds the requirements for Surface Burning Characteristics in accordance with ASTM E-84 of ≤75 Flame Spread Index and ≤450 Smoke Developed Index, or alternatively, ≤25 Flame Spread Index and ≤450 Smoke Developed Index.

Aspect 60. A polyurethane foam or a process for making a polyurethane foam according to any of the preceding Aspects, wherein the polyurethane foam meets or exceeds the requirements for omission of the code-prescribed ignition barrier in accordance with the International Code Council Evaluation Services Acceptance Criteria for Spray Polyurethane Foam, AC-377.

Aspect 61. A polyurethane foam or a process for making a polyurethane foam according to any of the preceding Aspects, wherein the polyurethane foam meets or exceeds the requirements for omission of the code-prescribed ignition barrier by way of special end use configuration testing in accordance with the International Residential Code, Chapter 3 and the International Building Code, Chapter 26.

Aspect 62. A polyurethane foam or a process for making a polyurethane foam according to any of the preceding Aspects, wherein the polyurethane foam meets or exceeds the requirements for omission of the code-prescribed thermal barrier by way of special end use configuration testing in accordance with the International Residential Code, Chapter 3 and the International Building Code, Chapter 26.

Aspect 63. A polyurethane foam or a process for making a polyurethane foam according to any of the preceding Aspects, wherein the polyurethane foam meets or exceeds the requirements for air impermeable insulation in accordance with ASTM E-2178.

Aspect 64. A polyurethane foam or a process for making a polyurethane foam according to any of the preceding Aspects, wherein the polyurethane foam meets or exceeds the requirements for physical properties in accordance with the International Code Council Evaluation Services Acceptance Criteria for Spray Polyurethane Foam, AC-377, Table 1, for Low Density Insulation.

What is claimed is:

1. A low density polyurethane (PUR) foam, the foam comprising the contact product of:
(a) a first reaction composition (A-side) comprising an aromatic polyisocyanate component having an isocyanate functionality of from about 2.5 to about 3.0; and
(b) a second reaction composition (B-side) comprising:
a polyether polyol characterized by a Hydroxyl Number (mg KOH/g) of from about 20 to about 45;
a polyurethane producing catalyst in a concentration of from 5 wt % to 12 wt % in the second reaction composition (B-side);
a flame retardant;
a surfactant; and
water;
wherein the first reaction composition (A-side) and the second reaction composition (B-side) are contacted in amounts to provide [1] an A-side:B-side volume ratio (v:v) of from 1.2:1 to 2:1, and [2] an Isocyanate Index of 20 to 40 (expressed as a percentage); and
the low density PUR foam has a density from about 0.25 lb/ft³ to about 0.45 lb/ft³.

2. The low density polyurethane (PUR) foam according to claim 1, wherein the polyisocyanate component comprises methylene diphenyl diisocyanate (MDI), polymeric methylene diphenyl diisocyanate (PMDI), or any combination thereof.

3. The low density polyurethane (PUR) foam according to claim 1, wherein the polyisocyanate component has an isocyanate functionality of from about 2.6 to about 2.9.

4. The low density polyurethane (PUR) foam according to claim 1, wherein the polyether polyol is characterized by any one of, or any combination of, the following:
a Hydroxyl Number (mg KOH/g) of from about 25 to about 42;
a weight average molecular weight or a number average molecular weight of from about 250 g/mol to about 6,000 g/mol; and
a hydroxyl functionality of from 2 to 8.

5. The low density polyurethane (PUR) foam according to claim 1, wherein the polyether polyol is present in the second reaction composition in a concentration of from about 10 wt % to about 50 wt %.

6. The low density polyurethane (PUR) foam according to claim 1, wherein the polyether polyol comprises:
polyoxyethylene diols (glycols), polyoxyethylene triols, polyoxyethylene tetrols, polyoxyethylene pentols, polyoxyethylene hexols, polyoxypropylene diols (glycols), polyoxypropylene triols, polyoxypropylene tetrols, polyoxypropylene pentols, polyoxypropylene hexols, or any combination thereof, or an alkylene oxide addition product to any one or more of these polyols; or
polypropylene glycol, polyethylene glycol, polytetramethylene glycol, glycerol triols, polyether tetrols, polyether pentols, aliphatic amine tetrols, aromatic amine tetrols, sorbitol, trimethyolpropane (TMP), or pentaerythritol, or an alkylene oxide addition product to any one or more of these polyols.

7. The low density polyurethane (PUR) foam according to claim 1, wherein the polyether polyol is formed from the addition of ethylene oxide, propylene oxide, or a combination thereof added simultaneously or sequentially, to an active hydrogen component selected from:
at least one polyol, at least one polyether polyol, at least one polyamine, or a combination thereof; or
ethylene glycol, propylene glycol, diethylene glycol, dipropylene glycol, tripropylene glycol, trimethyolpropane (TMP), glycerol, pentaerythritol, sorbitol, sucrose, ethylenediamine, toluene diamine, or any combination thereof.

8. The low density polyurethane (PUR) foam according to claim 1, wherein the polyether polyol is ethylene oxide terminated (having a high primary hydroxyl content), propylene oxide terminated (having a high secondary hydroxyl content), or a combination of ethylene oxide terminated and propylene oxide terminated.

9. The low density polyurethane (PUR) foam according to claim 1, wherein the polyether polyol is formed from the addition of ethylene oxide, propylene oxide, or a combination thereof added simultaneously or sequentially, to an active hydrogen component in the presence of a catalyst comprising a metal hydroxide, a double metal cyanide catalyst, or a combination thereof.

10. The low density polyurethane (PUR) foam according to claim 1, wherein the polyether polyol comprises:
an alkylene oxide adduct of a non-reducing sugar or a sugar derivative; an alkylene oxide adduct of phosphorus and polyphosphorus acids; an alkylene oxide adduct of polyphenols; polyols prepared from natural oils such as castor oil; an alkylene oxide adduct of a C₂ to C₆₀, C₂ to C₄₀, or C₂ to C₂₀ polyhydroxyalkane; or any combination thereof; or
an alkylene oxide adduct of 1,3-dihydroxypropane, 1,3-dihydroxybutane, 1,4-dihydroxybutane, 1,4-dihydroxyhexane, 1,5-dihydroxyhexane, 1,6-dihydroxyhexane, 1,2-dihydroxyoctane, 1,3-dihydroxyoctane, 1,4-dihydroxyoctane 1,6-dihydroxyoctane, 1,8-dihydroxyoctane, 1,10-dihydroxydecane, glycerol, 1,2,4-trihydroxybutane, 1,2,6-trihydroxyhexane, 1,1,1-trimethylolethane, 1,1,1-trimethylolpropane, pentaerythritol, caprolactone, polycaprolactone, xylitol, arabitol, sorbitol, mannitol, or any combination thereof.

11. The low density polyurethane (PUR) foam according to claim 1, wherein the polyether polyol comprises the addition reaction product of an alkylene oxide with an active hydrogen initiator, wherein
the alkylene oxide comprises ethylene oxide, propylene oxide, butylene oxide, isobutylene oxide, N-hexyl oxide, styrene oxide, trimethylene oxide, epichlorohydrin, or any combination thereof, and
the active hydrogen initiator comprises glycerin, triethanolamine, trimethyolpropane (TMP), or any combination thereof.

12. The low density polyurethane (PUR) foam according to claim 1, wherein the polyurethane producing catalyst comprises:
a primary amine compound, a secondary amine compound, a tertiary amine compound, a quaternary ammonium salt, or a radical forming agent;

13. The low density polyurethane (PUR) foam according to claim 1, wherein the polyurethane producing catalyst comprises Polycat® 15, Polycat® 37, Jeffcat® ZF 20, Jeffcat® Z-130, Jeffcat® LE 30, Dabco® T, Tetramethylguanidine, Dimethylaminopropylamine, Polycat® 30, Polycat® 31, Polycat® 37, Diethanolamine, Triethanolamine, Polycat® 142, Polycat® 141, Dabco® NE300, Dabco® NE310, Toyocat® D60, Dimethylaminoethanol, Jeffcat® ZF-10, Jeffcat® ZR-50, Niax® A-99, or any combination thereof.

14. The low density polyurethane (PUR) foam according to claim 1, wherein the polyurethane producing catalyst is present in the second reaction composition (B-side) in a concentration of from about 4 wt % to about 12 wt %.

15. The low density polyurethane (PUR) foam according to claim 1, wherein the flame-retardant comprises a phosphate compound, a halogenated compound, a non-halogenated compound, or a combination thereof.

16. The low density polyurethane (PUR) foam according to claim 1, wherein the flame retardant comprises:
a halogenated compound selected from tris(2-chloroisopropyl)phosphate (TCPP), tris(1,3-dichloroisopropyl)phosphate (TDCPP), tris (2-chloroethyl) phosphate (TCEP), PHT 4-Diol (tetrabromophthalate diol), PHT 4-Diol LV (tetrabromophthalate diol, low viscosity), Saytex® RB79, Saytex® RB7980, Ixol® B-251, Ixol® M-125, SaFRon® 6605, or any combination thereof; or
a non-halogenated compound selected from triethylphosphate, melamine, ammonium polyphosphate, VeriQuel® R100, pentaerythritol, sorbitol, xylitol, magnesium hydroxide, aluminum hydroxide, or any combination thereof.

17. The low density polyurethane (PUR) foam according to claim 1, wherein the flame-retardant comprises a brominated compound selected from:
an aryl-brominated polyester polyol, a brominated aliphatic compound, a brominated benzoate compound, a brominated phthalate compound, a polybrominated diphenylether, a polybrominated biphenyl, or any combination thereof; or
dibromoneopentyl glycol, tribromoneopentyl alcohol, n-propyl bromide, bis-[dibromopropoxydibromophenyl]propane, hexabromodecane, bis(tribromophenoxy)ethane, or any combination thereof.

18. The low density polyurethane (PUR) foam according to claim 1, wherein the flame retardant is present in the second reaction composition in a concentration of from about 4 wt % to about 42 wt %.

19. The low density polyurethane (PUR) foam according to claim 1, wherein the surfactant in the second reaction composition (B-side) comprises a non-ionic surfactant, a silicone surfactant, a non-silicone non-ionic surfactant, an organic surfactant, or a combination thereof.

20. The low density polyurethane (PUR) foam according to claim 19, wherein:
the non-ionic surfactant is selected from Surfonic® N95, Tergitol® NP9, Ecosurf® SA9, Surfonic® CO-25, Surfonic® ME400-CO, Surfonic® N120, Ecosurf® SA7, Ecosurf® SA4, Surfonic® ME550, or any combination thereof;
the silicone surfactant is selected from Silstab® 2760, Silstab® 2780, Silstab® 2550, Niax® L-6189, Vorasurf™ DC 198, Niax® L-5388, Niax® L-5345, Dabco® 198, Niax® Y16312, Niax® L-6186, Niax® L-6972, Niax® L-6884, Niax® L-5388, Silstab® 2755, Tegostab® B-8580, Tegostab® B-8870, or any combination thereof; and
the organic surfactant is selected from Dabco® LK443, Dabco® LK221, Vorsurf® 504, or any combination thereof.

21. The low density polyurethane (PUR) foam according to claim 1, wherein the surfactant in the second reaction composition (B-side) comprises an alkoxylation product of a fatty acid, a fatty acid ester, a fatty acid amide, an aliphatic alcohol, an aliphatic polyol, a sugar, or a sugar alcohol.

22. The low density polyurethane (PUR) foam according to claim 1, wherein the surfactant in the second reaction composition (B-side) comprises:
a sorbitan ester, a polyethoxylated sorbitan ester, a polyoxyethylene glycol alkyl ether, a polyoxypropylene glycol alkyl ether, a glucoside alkyl ether, a polyoxyethylene glycol octylphenol ether, a polyoxyethylene glycol alkylphenol ether, a polyoxyethylene glycol sorbitan alkyl ester, a sorbitan alkyl ester, or a combination thereof; or
an oxyethylated alkylphenol, an oxyethylated fatty alcohol, a paraffin oil, a castor oil ester, a ricinoleic acid ester, or a fatty alcohol.

23. The low density polyurethane (PUR) foam according to claim 1, wherein the surfactant is present in the second reaction composition in a concentration from about 0.05 wt % to about 6 wt %.

24. The low density polyurethane (PUR) foam according to claim 1, wherein the first reaction composition (A-side) further comprises a surfactant.

25. The low density polyurethane (PUR) foam according to claim 1, wherein the first reaction composition (A-side) consists essentially of the polyisocyanate component.

26. The low density polyurethane (PUR) foam according to claim 1, wherein the first reaction composition (A-side) comprises the polyisocyanate component in a concentration of at least about 95 wt % of the first reaction composition.

27. The low density polyurethane (PUR) foam according to claim 1, wherein the second reaction composition (B-side) further comprises a compatiblizing agent selected from a non-ionic surfactant, a non-silicone non-ionic surfactant, or a combination thereof, and the compatiblizing agent is present in the second reaction composition (B-side) in a concentration of from about 2 wt % to about 20 wt % in the second reaction composition.

28. The low density polyurethane (PUR) foam according to claim 1, wherein the water is present in the second reaction composition (B-side) in a concentration of from about 15 wt % to about 55 wt %.

29. The low density polyurethane (PUR) foam according to claim 1, wherein the second reaction composition further comprises a plasticizer, an emulsifier, a biocide, a bacteriostat, a filler, a dye or colorant, an anti-scorching agent, a cross-linker, an antioxidant, an antistatic agent, an stabilizing agent, a cell-opening agent, or any combination thereof.

30. The low density polyurethane (PUR) foam according to claim 1, wherein the second reaction composition further comprises a stabilizing agent comprising a glycerin/sucrose-initiated polyether polyol, an alkoxylated sucrose-glycerin based polyol, alkoxylated sucrose-glycerin amine based polyol, alkoxylated sucrose-diethylene glycol based polyol, alkoxylated sucrose-amine based polyol, alkoxylated amine based polyol, a Mannich based alkoxylated polyol, triethanolamine, diethanolamine, or 2-methyl-2,4-pentanediol.

31. The low density polyurethane (PUR) foam according to claim 1, wherein the first reaction composition, the second reaction composition, or both the first reaction composition and the second reaction composition further comprise a plasticizer selected from a phthalate plasticizer, a phosphate or phosphorus-containing plasticizer, or a benzoate plasticizer.

32. The low density polyurethane (PUR) foam according to claim 1, wherein the second reaction composition further comprises a cross-linker selected from a propoxylated sucrose-glycerin based polyol.

33. The low density polyurethane (PUR) foam according to claim 1, wherein:
the first reaction composition (A-side) and the second reaction composition (B-side) are used in amounts to provide an A-side:B-side volume ratio (v:v) of from about 1.25:1 to about 1.75:1 and an Isocyanate Index (as a percentage) from 20 to 35; and
the polyurethane foam has a density from about 0.27 lb/ft³ to about 0.42 lb/ft³.

34. The low density polyurethane (PUR) foam according to claim 1, wherein the polyurethane foam is formed into a barrier layer having an R-value of from 3.2 ft²·° F.·h/BTU·in to 4.2 ft²·° F.·h/BTU·in, in accordance with ASTM C-518.

35. The low density polyurethane (PUR) foam according to claim 1, wherein the polyurethane foam meets or exceeds the requirements for Surface Burning Characteristics in accordance with ASTM E-84 of ≤75 Flame Spread Index and ≤450 Smoke Developed Index, or alternatively, ≤25 Flame Spread Index and ≤450 Smoke Developed Index.

36. The low density polyurethane (PUR) foam according to claim 1, wherein the polyurethane foam meets or exceeds the requirements for omission of the code-prescribed ignition barrier in accordance with the International Code Council Evaluation Services Acceptance Criteria for Spray Polyurethane Foam, AC-377.

37. The low density polyurethane (PUR) foam according to claim 1, wherein the polyurethane foam meets or exceeds the requirements for omission of the code-prescribed ignition barrier by way of special end use configuration testing in accordance with the International Residential Code, Chapter 3 and the International Building Code, Chapter 26.

38. The low density polyurethane (PUR) foam according to claim 1, wherein the polyurethane foam meets or exceeds the requirements for omission of the code-prescribed thermal barrier by way of special end use configuration testing in accordance with the International Residential Code, Chapter 3 and the International Building Code, Chapter 26.

39. The low density polyurethane (PUR) foam according to claim 1, wherein the polyurethane foam meets or exceeds the requirements for air impermeable insulation in accordance with ASTM E-2178.

40. The low density polyurethane (PUR) foam according to claim 1, wherein the polyurethane foam meets or exceeds the requirements for physical properties in accordance with the International Code Council Evaluation Services Acceptance Criteria for Spray Polyurethane Foam, AC-377, Table 1, for Low Density Insulation.

41. A process for making a low density polyurethane (PUR) foam, the process comprising the steps of contacting:
(a) a first reaction composition (A-side) comprising an aromatic polyisocyanate component having an isocyanate functionality of from about 2.5 to about 3.0; and
(b) a second reaction composition (B-side) comprising:
a polyether polyol characterized by a Hydroxyl Number (mg KOH/g) of from about 20 to about 45;
a polyurethane producing catalyst in a concentration of from 5 wt % to 12 wt % in the second reaction composition (B-side);
a flame retardant;
a surfactant; and
water;
wherein the first reaction composition (A-side) and the second reaction composition (B-side) are contacted in amounts to provide [1] an A-side:B-side volume ratio (v:v) of from 1.2:1 to 2:1, and [2] an Isocyanate Index of 20 to 40 (expressed as a percentage); and
the low density PUR foam has a density from about 0.25 lb/ft³ to about 0.45 lb/ft³.

42. The process for making a low density polyurethane (PUR) foam according to claim 41, wherein the contacting occurs at high pressure by plural component dispensing at a pressure of from 500 psi (pounds per square inch) to 2,000 psi, alternatively from 750 psi to 1,750 psi, or alternatively from 1,000 psi to 1,500 psi.

43. The process for making a low density polyurethane (PUR) foam according to claim 41, wherein the contacting occurs by plural component dispensing at a temperature of from 100° F. to 160° F.; alternatively, from 110° F. to 150° F.; or alternatively, from 120° F. to 140° F.
